(19) United States
(12) Patent Application Publication
(10) Pub. No.: US 2022/0294677 A1
(43) Pub. Date: Sep. 15, 2022

(54) REFERENCE SIGNAL SIGNALING FOR SECONDARY CELLS

(71) Applicant: QUALCOMM Incorporated, San Diego, CA (US)

(72) Inventors: Kazuki Takeda, Tokyo (JP); Peter Gaal, San Diego, CA (US); Changhwan Park, San Diego, CA (US)

(21) Appl. No.: 17/687,433

(22) Filed: Mar. 4, 2022

Related U.S. Application Data
(60) Provisional application No. 63/159,413, filed on Mar. 10, 2021.

(51) Int. Cl. H04L 27/26; H04L 5/00; H04W 24/08

(52) U.S. Cl. CPC H04L 27/2613; H04L 5/0048; H04W 24/08

(57) ABSTRACT

Methods, systems, and devices for wireless communications are described. A network entity may identify a set of cells associated with performing communications with a user equipment (UE). The network entity may transmit, to the UE, a configuration signal indicating one or more sets of reference signal formats, each set of reference signal formats including a mapping of reference signal formats to respective cells of the set of cells. The network entity may transmit, to the UE, a trigger signal indicating an active set of reference signal formats of the one or more sets of reference signal formats, the trigger signal indicative of reference signal transmission from the cells of the set of cells in accordance with the reference signal formats associated with the active set of reference signal formats.

### CROSS REFERENCE

The present application for patent claims the benefit of U.S. Provisional Patent Application No. 63/159,413 by TAKEDA et al., entitled “REFERENCE SIGNAL SIGNALING FOR SECONDARY CELLS.” filed Mar. 10, 2021, assigned to the assignee hereof, and expressly incorporated by reference herein.

### FIELD OF TECHNOLOGY

The following relates to wireless communications, including reference signal signaling for secondary cells.

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities (e.g., base stations) or one or more network access nodes, each simultaneously supporting communication for multiple communication devices, which may be otherwise known as user equipment (UE).

### SUMMARY

The described techniques relate to improved methods, systems, devices, and apparatuses that support reference signal (RS) signaling for secondary cells (SCells). Generally, the described techniques provide for a network entity (e.g., a primary cell (PCell)) to configure a user equipment (UE) (e.g., using radio resource control (RRC) signaling) with multiple sets of RS formats, each set mapping RS formats to respective cells. For example, the network entity (e.g., base station) may configure the UE with a table of possible field values (e.g., corresponding to available aperiodic channel state information (A-CSI) request fields, or other fields) associated with a row in a table. The columns of the table may correspond to the PCell and available SCells of the UE. The point corresponding to a particular row/column may provide an indication of the RS format for the PCell or SCell. The network entity may transmit a trigger signal (a downlink control information (DCI) signal) to the UE indicating one of the field values. The UE may then determine the activation state of each cell in the row, and then use the column to determine the RS format for the corresponding cell. While the table and corresponding row may indicate a specific RS format to be monitored, the UE may elect to follow the table based on the activation state of the cell. If an SCell is deactivated, the UE may ignore the indicated RS format for monitoring. If an SCell is already activated, the UE may choose to follow the indicated RS format if the format corresponds to one that is appropriate for an already activated cell (e.g., an A-CSI-RS or a tracking reference signal (TRS)). If an SCell is being activated, the UE may choose to follow the indicated RS format if the format corresponds to one that is appropriate for the to-be-activated cell (e.g., a new temporary RS). Based on the configured and triggered RS format and the activation state of the cell, the UE may determine and implement the monitoring scheme for the cell(s).

A method for wireless communication at a UE is described. The method may include receiving a configuration signal indicating one or more sets of RS formats, each set of RS formats including a mapping of RS formats to respective cells of a set of cells, receiving a trigger signal indicating an active set of RS formats of the one or more sets of RS formats, the trigger signal indicative of RS transmission from the cells of the set of cells in accordance with the RS formats associated with the active set of RS formats, identifying an activation state for each cell in the set of cells, determining a monitoring scheme for at least one SCell of the set of cells based on a respective activation state of the at least one SCell and a respective RS format in the active set of RS formats, and performing the monitoring scheme with respect to RS transmissions from the at least one SCell.

An apparatus for wireless communication at a UE is described. The apparatus may include a processor, memory coupled with the processor, and instructions stored in the memory. The instructions may be executable by the processor to cause the apparatus to receive a configuration signal indicating one or more sets of RS formats, each set of RS formats including a mapping of RS formats to respective cells of a set of cells, receive a trigger signal indicating an active set of RS formats of the one or more sets of RS formats, the trigger signal indicative of RS transmission from the cells of the set of cells in accordance with the RS formats associated with the active set of RS formats, identify an activation state for each cell in the set of cells, determine a monitoring scheme for at least one SCell of the set of cells based on a respective activation state of the at least one SCell and a respective RS format in the active set of RS formats, and perform the monitoring scheme with respect to RS transmissions from the at least one SCell.

Another apparatus for wireless communication at a UE is described. The apparatus may include means for receiving a configuration signal indicating one or more sets of RS formats, each set of RS formats including a mapping of RS formats to respective cells of a set of cells, means for receiving a trigger signal indicating an active set of RS formats of the one or more sets of RS formats, the trigger signal indicative of RS transmission from the cells of the set of cells in accordance with the RS formats associated with the active set of RS formats, means for identifying an activation state for each cell in the set of cells, means for determining a monitoring scheme for at least one SCell of the set of cells based on a respective activation state of the at least one SCell and a respective RS format in the active set of RS formats, and means for performing the monitoring scheme with respect to RS transmissions from the at least one SCell.

A non-transitory computer-readable medium storing code for wireless communication at a UE is described. The code may include instructions executable by a processor to receive a configuration signal indicating one or more sets of RS formats, each set of RS formats including a mapping of RS formats to respective cells of a set of cells, receive a trigger signal indicating an active set of RS formats of the one or more sets of RS formats, the trigger signal indicative of RS transmission from the cells of the set of cells in accordance with the RS formats associated with the active set of RS formats, identify an activation state for each cell in the set of cells, determine a monitoring scheme for at least one SCell of the set of cells based on a respective activation state of the at least one SCell and a respective RS format in the active set of RS formats, and perform the monitoring scheme with respect to RS transmissions from the at least one SCell.

Some examples of the method, apparatuses, and non-transitory computer-readable medium described herein may further include operations, features, means, or instructions for determining that the activation state of the at least one SCell may be an activated state, where the at least one SCell may be already activated, determining that the RS format associated with the at least one SCell in the active set of RS formats includes a temporary aperiodic RS format, and performing the monitoring scheme for the at least one SCell by refraining from monitoring for the RS transmissions from the at least one SCell based on the activation state of the at least one SCell being the activated state and on the RS format associated with the at least one SCell in the active set of RS formats including the temporary aperiodic RS format.

Some examples of the method, apparatuses, and non-transitory computer-readable medium described herein may further include operations, features, means, or instructions for determining that a downlink transmission may be scheduled using overlapping resources that overlap with the RS transmissions from the at least one SCell and decoding the downlink transmission based on an assumption that the downlink transmission was either punctured or rate matched around the overlapping resources.

Some examples of the method, apparatuses, and non-transitory computer-readable medium described herein may further include operations, features, means, or instructions for determining that the activation state of the at least one SCell may be an activated state, where the at least one SCell may be already activated, determining that the RS format associated with the at least one SCell in the active set of RS formats includes a tracking RS format, and performing the monitoring scheme for the at least one SCell by monitoring for the RS transmissions from the at least one SCell based on the activation state of the at least one SCell being the activated state and on the RS format associated with the at least one SCell in the active set of RS formats including the tracking RS format.

Some examples of the method, apparatuses, and non-transitory computer-readable medium described herein may further include operations, features, means, or instructions for determining that the activation state of the at least one SCell may be a to-be-activated state, where the at least one SCell may be in a process of being activated, determining that the RS format associated with the at least one SCell in the active set of RS formats includes a tracking RS format, and performing the monitoring scheme for the at least one SCell by refraining from monitoring for the RS transmissions from the at least one SCell based on the activation state of the at least one SCell being the to-be-activated state and on the RS format associated with the at least one SCell in the active set of RS formats including the tracking RS format.

Some examples of the method, apparatuses, and non-transitory computer-readable medium described herein may further include operations, features, means, or instructions for determining that the activation state of the at least one SCell may be a to-be-activated activation state, where the at least one SCell may be in a process of being activated, determining that the RS format associated with the at least one SCell in the active set of RS formats includes a temporary aperiodic RS format, and performing the monitoring scheme for the at least one SCell by monitoring for the RS transmissions from the at least one SCell based on the activation state of the at least one SCell being the to-be-activated state and on the RS format associated with the at least one SCell in the active set of RS formats including the temporary aperiodic RS format.

Some examples of the method, apparatuses, and non-transitory computer-readable medium described herein may further include operations, features, means, or instructions for determining that the RS format associated with the at least one SCell in the active set of RS formats indicates a first RS format associated with a first activation state and a second RS format associated with a second activation state and selecting the monitoring scheme for the at least one SCell based on whether the at least one SCell may be in the first activation state or the second activation state.

Some examples of the method, apparatuses, and non-transitory computer-readable medium described herein may further include operations, features, means, or instructions for receiving a SCell activation message that indicates the at least one SCell may be to be activated at the UE and determining that the at least one SCell may be in the first activation state based on the SCell activation message.

Some examples of the method, apparatuses, and non-transitory computer-readable medium described herein may further include operations, features, means, or instructions for identifying that the active set of RS formats of the one or more sets of RS formats includes a temporary aperiodic RS format that includes a first portion of a tracking RS and a second portion of the tracking RS, where the first portion and the second portion may be in consecutive slots.

Some examples of the method, apparatuses, and non-transitory computer-readable medium described herein may further include operations, features, means, or instructions for identifying that the active set of RS formats of the one or more sets of RS formats includes a temporary aperiodic RS format that includes a first portion of a tracking RS and a second portion of the tracking RS, where the first portion and the second portion may be in consecutive slots and the tracking RS may be repeated in non-consecutive slots.

Some examples of the method, apparatuses, and non-transitory computer-readable medium described herein may further include operations, features, means, or instructions for identifying that the active set of RS formats of the one or more sets of RS formats includes a temporary aperiodic RS format that includes a first portion of a tracking RS and a second portion of the tracking RS, where the first portion and the second portion may be in non-consecutive slots.

Some examples of the method, apparatuses, and non-transitory computer-readable medium described herein may further include operations, features, means, or instructions for determining that the activation state of the at least one SCell may be an inactive state where the at least one SCell may be deactivated and performing the monitoring scheme for the at least one SCell by refraining from monitoring for the RS transmissions from the at least one SCell based on the activation state of the at least one SCell being the inactive state.

Some examples of the method, apparatuses, and non-transitory computer-readable medium described herein may further include operations, features, means, or instructions for receiving a SCell activation message that indicates that the at least one SCell may be to be activated at the UE, where the activation state for the at least one SCell may be based on the SCell activation message.

In some examples of the method, apparatuses, and non-transitory computer-readable medium described herein, the SCell activation message may be received using a medium access control (MAC) control element (CE) message.

Some examples of the method, apparatuses, and non-transitory computer-readable medium described herein may further include operations, features, means, or instructions for determining that the trigger signal may be received during a time window, the time window based on a delay time after the configuration signal may be received and a threshold time limit and applying the active set of RS formats based on the trigger signal being received during the time window.

Some examples of the method, apparatuses, and non-transitory computer-readable medium described herein may further include operations, features, means, or instructions for determining that the trigger signal may be received prior to a time window, the time window based on a delay time after the configuration signal may be received and a threshold time limit and refraining from applying the active set of RS formats based on the trigger signal being received prior to the time window.

Some examples of the method, apparatuses, and non-transitory computer-readable medium described herein may further include operations, features, means, or instructions for determining that the trigger signal may be received after a time window, the time window based on a delay time after the configuration signal may be received and a threshold time limit and applying an active RS format of the active set of RS formats based on the trigger signal being received after the time window.

In some examples of the method, apparatuses, and non-transitory computer-readable medium described herein, the configuration signal may be received in a radio resource control (RRC) message.

In some examples of the method, apparatuses, and non-transitory computer-readable medium described herein, the trigger signal may be received in a MAC CE or an aperiodic channel state information request field of a downlink control information (DCI).

A method for wireless communication at a network entity is described. The method may include identifying a set of cells associated with performing communications with a UE, transmitting, to the UE, a configuration signal indicating one or more sets of RS formats, each set of RS formats including a mapping of RS formats to respective cells of the set of cells, and transmitting, to the UE, a trigger signal indicating an active set of RS formats of the one or more sets of RS formats, the trigger signal indicative of RS transmission from the cells of the set of cells in accordance with the RS formats associated with the active set of RS formats.

An apparatus for wireless communication at a network entity is described. The apparatus may include a processor, memory coupled with the processor, and instructions stored in the memory. The instructions may be executable by the processor to cause the apparatus to identify a set of cells associated with performing communications with a UE, transmit, to the UE, a configuration signal indicating one or more sets of RS formats, each set of RS formats including a mapping of RS formats to respective cells of the set of cells, and transmit, to the UE, a trigger signal indicating an active set of RS formats of the one or more sets of RS formats, the trigger signal indicative of RS transmission from the cells of the set of cells in accordance with the RS formats associated with the active set of RS formats.

Another apparatus for wireless communication at a network entity is described. The apparatus may include means for identifying a set of cells associated with performing communications with a UE, means for transmitting, to the UE, a configuration signal indicating one or more sets of RS formats, each set of RS formats including a mapping of RS formats to respective cells of the set of cells, and means for transmitting, to the UE, a trigger signal indicating an active set of RS formats of the one or more sets of RS formats, the trigger signal indicative of RS transmission from the cells of the set of cells in accordance with the RS formats associated with the active set of RS formats.

A non-transitory computer-readable medium storing code for wireless communication at a network entity is described. The code may include instructions executable by a processor to identify a set of cells associated with performing communications with a UE, transmit, to the UE, a configuration signal indicating one or more sets of RS formats, each set of RS formats including a mapping of RS formats to respective cells of the set of cells, and transmit, to the UE, a trigger signal indicating an active set of RS formats of the one or more sets of RS formats, the trigger signal indicative of RS transmission from the cells of the set of cells in accordance with the RS formats associated with the active set of RS formats.

In some examples of the method, apparatuses, and non-transitory computer-readable medium described herein, the RS format associated with at least one SCell in the active set of RS formats indicates a first RS format associated with a first activation state and a second RS format associated with a second activation state.

Some examples of the method, apparatuses, and non-transitory computer-readable medium described herein may further include operations, features, means, or instructions for transmitting a SCell activation message to the UE that indicates the at least one SCell may be to be activated at the UE, where the at least one SCell may be in the first activation state based on the SCell activation message.

Some examples of the method, apparatuses, and non-transitory computer-readable medium described herein may further include operations, features, means, or instructions for transmitting a SCell activation message that indicates that at least one SCell may be to be activated at the UE, where an activation state for the at least one SCell may be based on the SCell activation message.

In some examples of the method, apparatuses, and non-transitory computer-readable medium described herein, the SCell activation message may be transmitted using a MAC CE message.

In some examples of the method, apparatuses, and non-transitory computer-readable medium described herein, the configuration signal may be transmitted in an RRC message.

In some examples of the method, apparatuses, and non-transitory computer-readable medium described herein, the trigger signal may be transmitted in a MAC CE or an aperiodic channel state information request field of a DCI.

### BRIEF DESCRIPTION OF THE DRAWINGS

FIG. 1 illustrates an example of a wireless communication system that supports reference signal (RS) signaling for secondary cells (SCells) in accordance with aspects of the present disclosure.

FIG. 2 illustrates an example of a wireless communication system that supports RS signaling for SCells in accordance with aspects of the present disclosure.

FIGS. 3A and 3B illustrate examples of a RS format configuration that supports RS signaling for SCells in accordance with aspects of the present disclosure.

FIGS. 4A, 4B, and 4C illustrate examples of a RS format structure that supports RS signaling for SCells in accordance with aspects of the present disclosure.

FIG. 5 illustrates an example of a process that supports RS signaling for SCells in accordance with aspects of the present disclosure.

FIGS. 6 and 7 show block diagrams of devices that support RS signaling for SCells in accordance with aspects of the present disclosure.

FIG. 8 shows a block diagram of a communications manager that supports RS signaling for SCells in accordance with aspects of the present disclosure.

FIG. 9 shows a diagram of a system including a device that supports RS signaling for SCells in accordance with aspects of the present disclosure.

FIGS. 10 and 11 show block diagrams of devices that support RS signaling for SCells in accordance with aspects of the present disclosure.

FIG. 12 shows a block diagram of a communications manager that supports RS signaling for SCells in accordance with aspects of the present disclosure.

FIG. 13 shows a diagram of a system including a device that supports RS signaling for SCells in accordance with aspects of the present disclosure.

FIGS. 14 through 17 show flowcharts illustrating methods that support RS signaling for SCells in accordance with aspects of the present disclosure.

### DETAILED DESCRIPTION

Recently, there has been a agreement to use of a temporary reference signal (RS) to improve secondary cell (SCell) activation. The temporary RS may be a RS that is different from existing RSs, and may be optimized for fast activation of an SCell. For example, a primary cell (PCell) may configure the SCell that is to be activated to transmit the temporary RS in order to allow a user equipment (UE) to quickly perform automatic gain control (AGC) where the UE adjusts its receive amplifier gain as well perform time/frequency tuning with the SCell. Without the temporary RS, the UE would use synchronization signal block (SSB) transmissions, which have a relatively long periodicity with respect to activating an SCell. A UE may be signaled that an SCell may be configured to transmit these temporary RSs, but there are times when the UE may want additional flexibility in deciding whether to monitor for the temporary RSs. In some cases, the UE may prefer to monitor an already active SCell using an aperiodic channel state information reference signal (A-CSI-RS), a tracking reference signal (TRS), and the like, for channel performance measurements/tuning.

Aspects of the disclosure are initially described in the context of wireless communication systems. Generally, the described techniques provide for a network entity (e.g., a PCell) to configure a UE (e.g., using radio resource control (RRC) signaling) with multiple sets of RS formats, each set mapping RS formats to respective cells. For example, the network entity (e.g., base station) may configure the UE with a table of possible field values (e.g., corresponding to available aperiodic channel state information (A-CSI) request fields, or other fields) associated with a row in a table. The columns of the table may correspond to the PCell and available SCells of the UE. The point corresponding to a particular row/column may provide an indication of the RS format for the PCell or SCell. The network entity may transmit a trigger signal (a downlink control information (DCI) signal) to the UE indicating one of the field values. The UE may then determine the activation state of each cell in the row, and then use the column to determine the RS format for the corresponding cell. While the table and corresponding row may indicate a specific RS format to be monitored, the UE may elect to follow the table based on the activation state of the cell. If an SCell is deactivated, the UE may ignore the indicated RS format for monitoring. If an SCell is already activated, the UE may choose to follow the indicated RS format if the format corresponds to one that is appropriate for an already activated cell (e.g., an A-CSI-RS or a TRS). If an SCell is being activated, the UE may choose to follow the indicated RS format if the format corresponds to one that is appropriate for the to-be-activated cell (e.g., a new temporary RS). Based on the configured and triggered RS format and the activation state of the cell, the UE may determine and implement the monitoring scheme for the cell(s).

Aspects of the disclosure are further illustrated by and described with reference to apparatus diagrams, system diagrams, and flowcharts that relate to reference signal signaling for SCells.

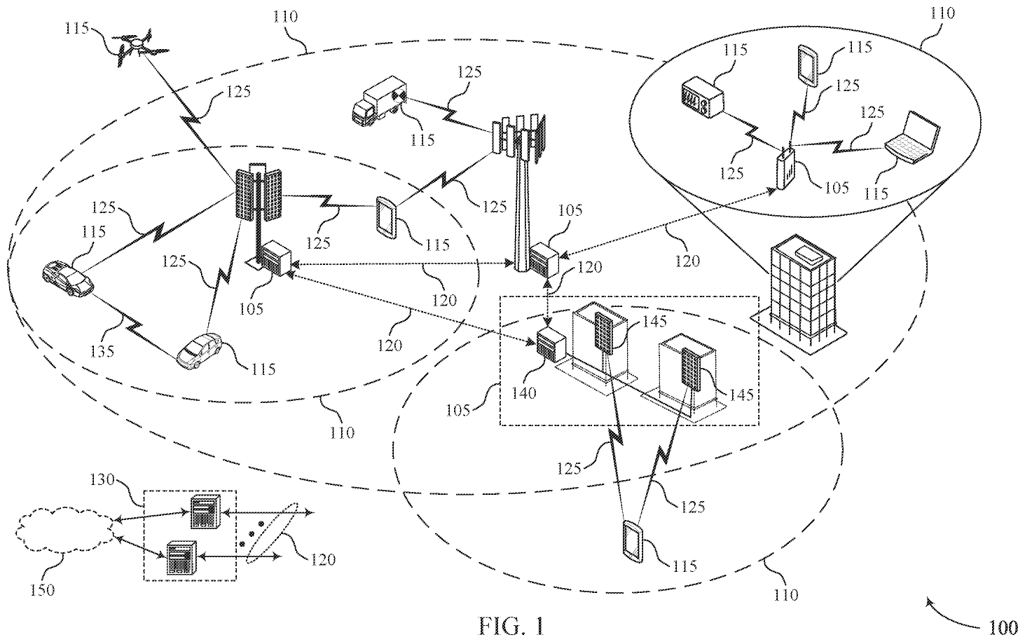

FIG. 1 illustrates an example of a wireless communication system 100 that supports reference signal signaling for SCells in accordance with aspects of the present disclosure. The wireless communication system 100 may include one or more network entities 105, one or more UEs 115, and a core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof.

The network entities 105 may be dispersed throughout a geographic area to form the wireless communication system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a base station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities 105, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communication system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications over a particular carrier bandwidth or may be configurable to support communications over one of a set of carrier bandwidths. In some examples, the wireless communication system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communication system 100 may include, for example, a heterogeneous network in which different types of the network entities 105 provide coverage for various geographic coverage areas 110 using the same or different radio access technologies.

The wireless communication system 100 may support synchronous or asynchronous operation. For synchronous operation, the network entities 105 may have similar frame timings, and transmissions from different network entities 105 may be approximately aligned in time. For asynchronous operation, the network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station may be distributed across various network devices (e.g., radio heads and ANCs) or consolidated into a single network entities 105 (e.g., radio heads and ANCs) or consolidated into a single network entity 105 (e.g., a base station).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive a configuration signal indicating one or more sets of RS formats, each set of RS formats including a mapping of RS formats to respective cells of a set of cells. The UE 115 may receive a trigger signal indicating an active set of RS formats of the one or more sets of RS formats, the trigger signal indicative of RS transmission from the cells of the set of cells in accordance with the RS formats associated with the active set of RS formats. The UE 115 may identify an activation state for each cell in the set of cells. The UE 115 may determine a monitoring scheme for at least one SCell of the set of cells based on a respective activation state of the at least one SCell and a respective RS format in the active set of RS formats. The UE 115 may perform the monitoring scheme with respect to RS transmissions from the at least one SCell.

A network entity 105 may identify a set of cells associated with performing communications with a UE 115. The network entity 105 may transmit, to the UE 115, a configuration signal indicating one or more sets of RS formats, each set of RS formats including a mapping of RS formats to respective cells of the set of cells. The network entity 105 may transmit, to the UE 115, a trigger signal indicating an active set of RS formats of the one or more sets of RS formats, the trigger signal indicative of RS transmission from the cells of the set of cells in accordance with the RS formats associated with the active set of RS formats.

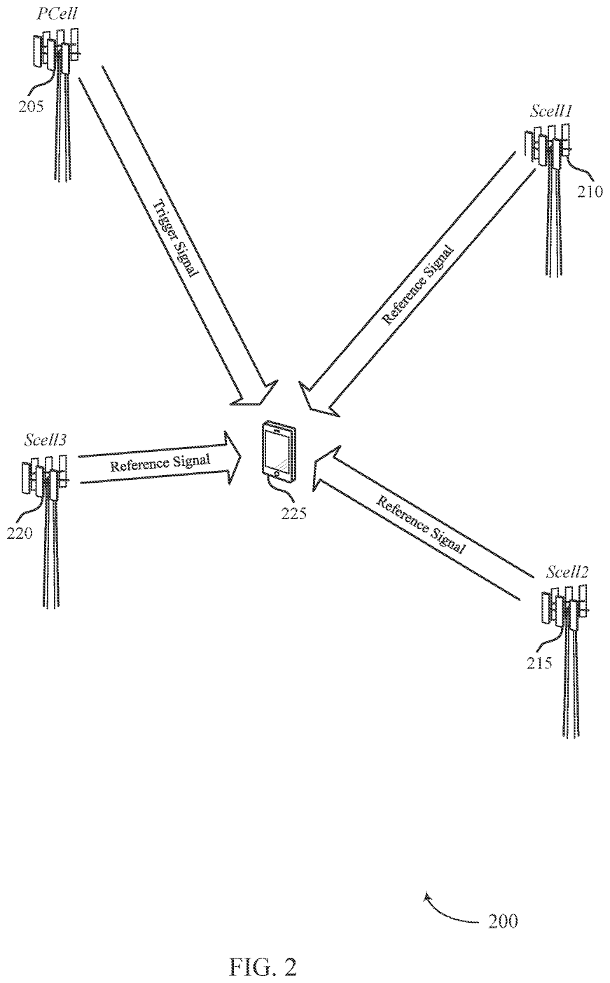

FIG. 2 illustrates an example of a wireless communication system 200 that supports RS signaling for SCells in accordance with aspects of the present disclosure. Wireless communication system 200 may implement aspects of wireless communication system 100. Wireless communication system 200 may include network entity 205, network entity 210, network entity 215, network entity 220, and UE 225, which may be examples of the corresponding devices described herein.

That is, in some aspects network entity 205 may be configured to serve for a PCell for UE 225 and network entity 210, network entity 215, and/or network entity 220 may be SCells available for communications with UE 225 (e.g., either active SCell(s), to-be-activated SCell(s), or inactive SCell(s)). However, it is to be understood that the PCell and SCell(s) may be associated with the same network entity and/or may be associated with different network entities. In the example where the PCell and SCell are associated with different network entities, such network entities may coordinate aspects of communications with UE 225 wirelessly and/or via a wired connection (e.g., via a backhaul connection).

Some wireless communication systems may support a temporary RS to expedite the activation process during SCell activation to improve efficiency. The temporary RS may be supported for SCell activation in, for example, frequency range one (FR1), frequency range two (FR2), and/or some other FR(s). Broadly, the temporary RS may support functionalities related to AGC settling, time and/or frequency tracking/tuning during SCell activation, and the like.

In some aspects, the temporary RS may also be referred to as an aperiodic RS, which may be an example of a TRS, an aperiodic CSI-RS, a persistent CSI-RS, a semi-persistent CSI-RS, a sounding reference signal (SRS), a reference signal based on PSS/SSS, a combination of two or more, and the like. Other examples of RS types that may be configured as an aperiodic reference signal include, but are not limited to, a phase tracking reference signal, a beam tracking/management reference signal, and the like. Accordingly, the terms TRS, aperiodic reference signal, new temporary RS, and the like, may be used interchangeably herein.

Accordingly, in some examples a TRS waveform may be selected as the temporary RS (e.g., as an aperiodic RS) for SCell activation. In some examples, the temporary RS may be triggered by DCI, MAC CE, and the like. UE 225 may measure the triggered temporary RS during the SCell activation procedure no earlier than within a configured time threshold (e.g., no earlier than a slot m).

Conventionally, upon receiving the SCell activation command in a slot, UE 225 may support transmitting a valid CSI report and applying the actions related to the SCell activation command for the SCell being activated no later than in slot

$$n + \frac{{T}_{HARQ} + {T}_{activaion\_time} + {T}_{CSI\_Reporting}}{NR Slot Length} .$$

T_{HARQ} may refer to the timing (in ms) between the downlink data transmission and the acknowledgment of the downlink data transmission (e.g., HARQ-ACK feedback). T_{activation_time} may refer to the SCell activation delay in ms. If the SCell being activated is known and belongs to FR1. T_{activation_time} may be T_{FirstSSB}+5 ms if the SCell measurement cycle is equal to or smaller than 160 ms (e.g., to support fine tracking) or T_{FirstSSB_Max}+Tᵣₛ+5 ms if the SCell measurement cycle is larger than 160 ms (e.g., to support AGC plus fine time/frequency tracking). If the SCell is unknown and belongs to FR1, provided that certain conditions are satisfied, T_{activation_time} may be T_{FirstSSB_Max}+T_{SMTC_Max}+2*Tᵣₛ+5 ms (e.g., to support AGC, fine time/frequency tracking, and SSB detection). Tᵣₛ may generally refer to the SSB-based measurement and timing configuration (SMTC) periodicity of the SCell being activated if the UE has been provided with an SMTC configuration for the SCell in the SCell addition message. Otherwise, Tᵣₛ may refer to the SMTC configured in the measObjectNR having the same SSB frequency and subcarrier spacing. If UE 225 is not provided an SMTC configuration or measurement object on this frequency, the requirement which involves Tᵣₛ may be applied with Tᵣₛ being equal to 5 ms assuming the SSB transmission periodicity is 5 ms. T_{FirstSSB} may refer to the time to the end of the first complete SSB burst indicated by the SMTC after slot

$$n + {T}_{HARQ} + \frac{{T}_{HARQ} + 3 ms}{NR slot length} .$$

T_{FirstSSB_Max} may refer to the time to the end of the first complete SSB burst indicated by the SMTC after slot

$$n + {T}_{HARQ} + \frac{{T}_{HARQ} + 3 ms}{NR slot length} .$$

This may fulfill the requirement that, in FR1 and in the case of intra-band SCell activation, the occasion when all active serving cells and SCells being activated or released are transmitting SSB burst in the same slot. In the case of inter-band SCell activation, this may refer to the first occasion when the SCell being activated is transmitting an SSB burst. In FR2, this may refer to the occasion when all active serving cells and SCells being activated or released are transmitting SSB burst in the same slot.

Accordingly and for an SCell activation using a temporary RS in FR1 and with a certain condition (e.g., SCell measurement cycle<=160 ms), the SCell activation delay may be equal to:

$$\frac{{T}_{HARQ} + {T}_{activaion\_time} + {T}_{CSI\_Reporting}}{NR Slot Length} .$$

Again, T_{HARQ} generally refers to the timeline until HARQ-ACK is transmitted. T_{Activation_time} generally refers to T_{FirstTempRS}+5 ms, where T_{FirstTempRS} is the time to the start or end of the temporary reference signal after n+T_{HARQ}+3 ms. T_{CSI Reporting} generally refers to the delay until the first available CSI report including uncertainties of a CSI resource in a CSI report.

Accordingly, in some examples the temporary RS may be a tracking RS (TRS) (e.g., a non-zero power (NZP)-CSI-RS resource set configured with a parameter trs-Info). Conventionally, this may include two NZP-CSI-RS resources (on two OFDM symbols) being configured in a slot or four NZP-CSI-RS resources being configured in two consecutive slots. The TRS may span over the bandwidth of the downlink BWP, which will be active when the SCell is activated (e.g., at least initially). The downlink BWP may correspond to the first-active-DL-BWP-id configured for UE 225.

The slot where the temporary RS is transmitted, the NZP-CSI-RS resource set index, or any of the combinations, may be indicated by the triggering signaling for the temporary RS. In one option this may include the triggering signaling being conveyed in a MAC CE carried by PDSCH. For example, the MAC CE triggering the temporary RS may be carried by the PDSCH that also carries the MAC CE activating the SCell. In another example the MAC CE triggering the temporary RS may be indicated by a PDSCH that is different from the PDSCH that carries the MAC CE activating the SCell. Another option may include the trigger signaling being conveyed in a DCI. For example, this may include the DCI scheduling the PDSCH that carries the MAC CE activating the SCell. In another example, this may include a DCI other than the DCI scheduling the PDSCH that carries the MAC CE activating the SCell.

According to such conventional techniques, the temporary RS time domain allocations may generally consist of two CSI-RS resources being configured within a slot or four CSI-RS resources being configured into consecutive slots (which may be the same across the two consecutive slots). This may be defined by a higher layer parameter CSI-RS-resourceMapping.

Accordingly, fast SCell activation may be improved using temporary RS configurations. In this context, the SCell activation delay may correspond to:

$$\frac{{T}_{HARQ} + {T}_{activaion time} + {T}_{CSI reporting}}{NR slot length} .$$

T_{HARQ} may again correspond to the timeline until ACK is transmitted. T_{activation time} may generally refer to T_{temp RS}+5 ms, where T_{temp RS} is the time to the TRS after n+T_{HARQ}+3 ms. In some aspects, the activation time may correspond to the time between UE 225 transmitting HARQ-ACK for the activation command, the time it takes UE 225 to measure the TRS, and the time until UE 225 is ready to transmit CSI-RS reporting based on the measurement.

For example, for a known SCell with measurement cycles greater than 160 ms, a temporary RS may include two portions of RS symbols separated in time. One portion may be used for AGC and the other portion may be used for fine time/frequency tracking. The temporary RS may be a set of TRSs (e.g., NZP-CSI-RS resource sets with trs-info). In another option, a temporary RS may include one portion of RS symbols and the UE may use the temporary RS and an SSB. For example, the temporary RS may be used for AGC and the SSB may be used for fine time/frequency tracking, or vice versa.

For an unknown SCell, a temporary RS may include four portions of RS symbols that are separated in time. The temporary RS may be a set of TRSs (e.g., NZP-CSI-RS resource sets with trs-info). In another option, a temporary RS may include one or multiple portions of RS symbols and the UE may use the temporary RSs and SSB(s). For example, at least four portions of one or multiple temporary RS(s) and one or multiple SSB(s) may be used. Depending on the number of portions of the temporary RS, the number of necessary SSBs may be different and the SCell activation delay in this situation may be different.

While this approach may be suitable for an SCell being activated with an SCell measurement cycle <=160 ms, other issues may arise for an SCell being activated with the SCell measurement cycle >160 ms. For an SCell measurement cycle >160 ms, two SSBs are typically used. Since the two SSBs are separated in the time domain by at least 5 ms, UE 225 has sufficient time to process AGC (e.g., using the first SSB) and to track sequentially (e.g., using the second SSB for time/frequency tracking/fine tuning). However, the temporary RS techniques discussed above may be limited such that the NZP-CSI-RS resources are present either in one slot or in two consecutive slots. That is, since the NZP-CSI-RS resources are contained within a short duration (e.g., up to within two slots). UE 225 may not have sufficient time to process AGC and also perform fine tracking. That is, the slot duration (e.g., NR slot length) may be 1 ms, 0.5 ms, 0.25 ms, and 0.125 ms for SCS of 15 kHz, 30 kHz, 60 kHz, and 120 kHz, respectively. Limiting configuration for the temporary RS resources to within a single slot or to span two consecutive slots may not provide sufficient time for UE 225 to perform AGC operations and then fine tuning using the temporary RSs.

Moreover, for the cases where AGC and time/frequency tracking are required for SCell activation, UE 225 may require a certain level of a time gap between the RS for AGC and the RS used for time/frequency tracking. For example, a TRS (e.g., NZP-CSI-RS resource set with trs-info) may be used for SCell activation. The TRS may contain multiple NZP-CSI-RS symbols, which are in two consecutive slots with a minimum of four OFDM symbols separation. This may be insufficient in some situations. Accordingly, aspects of the described techniques provide for a sufficient time gap between the two portions of the temporary RS (e.g., the first and second portions of temporary RS(s) may be split in the time domain a sufficient distance to support AGC as well as fine time/frequency tracking).

However, for an SCell that is already active, such structure for the temporary RS may be unnecessary, but an A-CSI-RS for CSI measurement and TRS (e.g., NZP-CSI-RS resource set with trs-info) may still be useful for an active serving cell. That is, other forms of temporary RS design are for some specific condition/purpose (e.g., a known cell with a measurement cycle >160 ms or an unknown cell), and therefore may not be useful for an already active cell (e.g., for a cell with an activation state of already active).

Accordingly, aspects of the described techniques may include network entity 205 (e.g., the PCell serving UE 225 in this example) configuring UE 225 with one RS configuration for each cell of each codepoint in a configured table. For example, network entity 205 may transmit or otherwise provide configuration signaling to UE 225 that identifies or otherwise indicates set(s) of RS formats, where each set of RS format includes mapping RS formats to respective cells of the set of cells (e.g., to each of network entity 205, network entity 210, network entity 215, and/or network entity 220). In some aspects, the configuration signal may use RRC signaling, or other signaling techniques from network entity 205 to UE 225.

In some examples, the set(s) of RS formats may include a table listing (e.g., indicating), for each cell available for communicating with UE 225, a RS format for the cell to use. The table may include a plurality of columns, with the first column corresponding to field value (e.g., the indication) and the other columns corresponding to each cell (e.g., the second column corresponding to the PCell, the third column corresponding to SCell1, and so forth). The table may include a plurality of rows, with each row having a set of RS format for the cell(s) in the corresponding column(s). As discussed, each row may also include a column (e.g., the first column) corresponding to an indication provided in a trigger signal that signals which row of the table is activated for RS transmission (e.g., indicating which set of RS formats are active for the cells). For example, the first column in the table may correspond to a field indicating an active set of RS formats of the set(s) of RS formats. That is, the field value column may include a different field value for each row, with the field value indicated in a trigger signal identifying which row/set of RS formats are active for the cells to use for RS transmissions.

Accordingly, network entity 205 may transmit or otherwise provide to UE 225 the trigger signal indicating the active set of RS formats from the set(s) of RS formats. The trigger signal may identify or otherwise indicate a RS transmission from the cells according to the RS formats associated with the active set of RS formats. That is, the trigger signal (e.g., a MAC CE, DCI, etc.) may include a bit, field, parameter, etc., that is set to a particular field value corresponding to the first column in the table. That particular field value corresponding to a particular row in the table may signal which RS formats are active for the RS transmissions from the cells. The active RS format(s) in the row corresponding to the indicated field value may signal, to the cell in the corresponding column, which RS format each cell is to use for such RS transmissions. In one non-limiting example, the indication provided in the trigger signal may be provide in an A-CSI request field of a DCI. However, the indication is not limited to the A-CSI request field of a DCI, but instead may be signaled in a different field and/or in a different signal (e.g., in a MAC CE).

In some aspects, the active RS formats may be based on the activation state of each cell. For example, UE 225 may identify or otherwise determine which cells are active for communications with UE 225 or are inactive (e.g., deactivated) for communications with UE 225. Each cell may be in either an inactive state, in a currently active state, or in a to-be-activated state (e.g., the cell was inactive, but is transitioning to an active state to support communications with UE 225).

Based on the activation state of each cell, in addition to the active set of RS formats indicated in the trigger signal, UE 225 may select, identify, or otherwise determine a monitoring scheme for at least one SCell in the set of cells. That is, UE 225 may generally determine how it will monitor for RS transmissions from the active and/or to-be-activated cells using the RS formats from the row of the table that has been indicated in the trigger signal.

The monitoring scheme may generally determine if and/or how UE 225 will monitor for RS transmissions from the cell(s) in the set of cell(s). For example, UE 225 may use the active set of RS formats in addition to the activation state of each cell to determine whether to, and if so how, to monitor for RS transmissions from the cell(s). Accordingly, UE 225 may implement the monitoring scheme (e.g., perform) for RS transmissions from at least one cell in the set of cells.

Accordingly, aspects of the described techniques provide for using an A-CSI request field (in some examples) of an uplink DCI (e.g., DCI formats 0_1 and/or 0_2) to indicate the triggered set of RS formats. For a cell associated with a field value, the RRC signaling may be used as the configuration signal to configure the temporary RS(s) format for each cell. The RS format may be a legacy TRS (e.g., NZP-CSI-RS resource set with trs-info) or may be a new temporary RS format. For example, the codepoint in the trigger signal (e.g., the indicated field value) may indicate a legacy TRS for all of the indicated cells, or a new temporary RS for all of the indicated cells, or a legacy TRS for some cells and the new temporary RS format for other cells. As discussed, the association between a particular codepoint (e.g., the field value indicated in the trigger signal) and the configuration for each cell (e.g., the sets of RS formats) may be provided via the configuration signal (e.g., RRC signaling). In the situation where a cell not included in the configured set(s) of RS formats, UE 225 may disregard that cell when triggered by the trigger signal. That is, if one or more SCells having associated RS format configuration for a codepoint is/are deactivated (e.g., in an inactive activation state) and if the codepoint is indicated by the A-CSI request field, UE 225 may ignore the indication for the deactivated cell(s).

If one or more SCell(s) having an associated RS format configuration for a codepoint is/are active (e.g., in an active activation state) and if the RS format is for a new temporary RS and if the codepoint is indicate by the A-CSI request field, UE 225 may have different options available. In one option, UE 225 may ignore the indication (e.g., does not consider that the new temporary RS as being transmitted by the already activated cell(s)). For example, UE 225 may identify or otherwise determine that the activation state for at least one SCell is an activated state (e.g., already activated). UE 225 may identify or otherwise determine that the RS format associated with the SCell is the temporary aperiodic RS format (e.g., the new RS format). Accordingly, in some examples UE 225 may implement or otherwise adopt a monitoring scheme that includes refraining from monitoring for the RS transmissions from the SCell. This may be based, at least in some aspects, on the already activated activation state and the SCell being configured with the temporary aperiodic RS format.

Refraining from monitoring for the RS transmissions from the SCell(s) based on the already activated activation state and the temporary aperiodic RS format being configured and activated by the trigger signal may include different options for UE 225. In one option, UE 225 simply ignores RS transmission(s) from the SCell. In another option, if there is a PDSCH scheduled on the SCell which is overlapped with the RS resource elements, then UE 225 may assume that the PDSCH resource elements are rate-matched or punctured around the resource elements for the RS. That is, UE 225 may determine that a downlink transmission (e.g., PDSCH) is scheduled using overlapping resources that overlap, at least to some degree, with the RS transmissions from the SCell. In this example, UE 225 may decode the downlink transmission based on an assumption that the downlink transmission was either punctured or rate matched around the overlapping resources.

In some examples, UE 225 may follow the RS format configured via RRC signaling and the active set of RS formats indicated in the trigger signal (e.g., may consider that the RS is being transmitted by the cell(s)). For example, UE 225 may determine that the SCell is in the activated state and that the RS format associated with the SCell is the TRS format. The monitoring scheme implemented or otherwise adopted by UE 225 in this example may include UE 225 monitoring for the RS transmissions from the SCell(s) according to the configuration signal and the trigger signal. The monitoring may be, at least for this example, based on the already activated activation status and the RS format configured for the SCell(s) being the TRS RS format (e.g., a legacy TRS format).

In some example, cell(s) in the set of cell(s) may be in a to-be-activated activation state (e.g., are in the process of being activated). In this situation, the monitoring scheme implemented or otherwise adopted by UE 225 may be based on the RS format for the SCell(s) being activated. For example, if UE 225 determines that the RS format for the SCell(s) in the active set of RS formats is a TRS format, then the monitoring scheme may include UE 225 refraining from monitoring for the RS transmissions from the to-be-activated SCell(s). In the situation where UE 225 determines that the RS format for the SCell(s) in the active set of RS formats is the temporary aperiodic RS format (e.g., the new RS format), then UE 225 may implement or otherwise adopt a monitoring scheme that includes UE 225 monitoring for the RS transmission from the to-be-activated SCell(s).

Continuing with the SCell activation scenario, in some examples UE 225 may receive a SCell activation message indicating that the SCell(s) is/are to be activated for communications with UE 225. The SCell activation message may use MAC CE signaling and may identify the SCell(s) being activated. That is, in some examples the SCell activation message may be transmitted separately from the trigger signal. In other example, the trigger signal (e.g., DCI) may be used as the SCell activation message (e.g., the DCI may schedule the PDSCH carrying the MAC CE SCell activation message).

Accordingly. UE 225 may use the activation state of each cell in the set of cells in addition to the active set of RS formats indicated by the trigger signal to develop a monitoring scheme for UE 225 to use for monitoring for RS transmissions form the cell(s) in the set of cells. UE 225 may perform the monitoring scheme for each cell in the set of cells according to the active set(s) of RS formats and the configuration of the set(s) of RS formats.

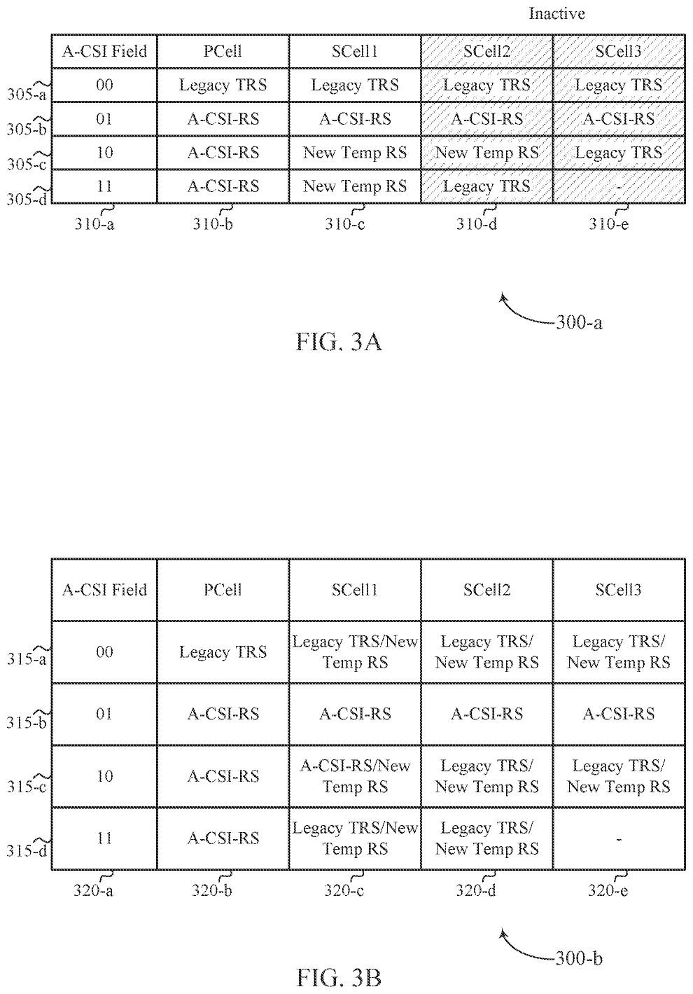

FIGS. 3A and 3B illustrate examples of a RS format configuration 300 that supports RS signaling for SCells in accordance with aspects of the present disclosure. RS format configuration 300 may implement aspects of wireless communication systems 100 and/or 200. Aspects of RS format configuration 300 may be implemented by a UE and/or network entity(ies), which may be examples of the corresponding devices described herein. The network entity(ies) in this example may be configured as PCell and/or SCells (e.g., a set of cells) available for communications with the UE. Broadly. RS format configuration 300-a of FIG. 3A and RS format configuration 300-b both illustrate non-limiting examples of one or more sets of RS formats indicated for a UE, with RS format configuration 300-a including a single RS format configured for each set of RS formats for each cell, where RS format configuration 300-b including multiple RS formats configured for each set of RS formats for some cells.

As discussed above, aspects of the described techniques provide various mechanisms that may improve RS transmissions from cell(s) available for communications with the UE. For example, a network entity may use configuration signaling (e.g., RRC signaling) to configure or otherwise indicate to the UE one or more sets of RS formats.

Turning first to RS format configuration 300-a of FIG. 3A, each set of RS formats may correspond to a row 305. For example, row 305-a may correspond to a first set of RS formats, row 305-b may correspond to a second set of RS formats, row 305-c may correspond to a third set of RS formats, and row 305-d may correspond to a fourth set of RS formats. It is to be understood that the set of RS formats may include more or fewer sets of RS formats (e.g., more rows 305 or fewer rows 305). The top row (not labeled) of RS format configuration 300-a may simply be a header row.

Each set of RS formats may map RS formats to respective cells of the set of cells. The set of cells in this example may correspond to a PCell mapped to column 310-b, SCell1 mapped to column 310-c, SCell2 mapped to column 310-d, and SCell3 mapped to column 310-e. Column 310-a may correspond to a set of field values that can be included in a trigger signal to indicate which set of RS formats are active. It is to be understood that the set of cells may include more or fewer cells in the sets of cells (e.g., more columns 310 or fewer columns 310). The first column 310-a generally corresponds to a set of field values that may be provided in a triggers signal to indicate which set of RS formats are active.

The network entity may then transmit a trigger signal to the UE that carries or otherwise conveys an indication of an active set of RS formats of the sets of RS formats. Broadly, the trigger signal may indicate that RS transmissions from the cells in the set of cells are to be performed in accordance with the RS formats associated with the active set of RS formats. In some examples, this may include the trigger signal carrying or otherwise conveying a field value from column 310-a. For example, the trigger signal may indicate “00” to signal that the first set of RS formats are active for the RS transmissions, to indicate “01” to signal that the second set of RS formats are active for the RS transmissions, and so forth.

The UE may then determine the activation state for each cell in the set of cells. The activation state may generally correspond to an active activation state (e.g., that the cell is already in the active state), an inactive state, or a to-be-activated state (e.g., for a cell that is being activated for communications with the UE). Cell(s) in the active state may be known to the UE (e.g., since the UE is already communicating with the active cell(s)). Cell(s) in the inactive state may be known or unknown to the UE (e.g., the UE may or may not have been configured with inactive cell(s)). Cell(s) in the to-be-activated state may be known to the UE based on the network entity transmitting or otherwise conveying a SCell activation message to the UE identifying which cell(s) are being activated for communications with the UE. In the non-limiting example illustrated in RS format configuration 300-a of FIG. 3A, the PCell and SCell1 are in the active or to-be-activated state and SCell2 and SCell3 are in the inactive state.

Based on the activation state of each cell as well as the active set of RS formats indicated in the trigger signal, the UE may select, determine, or otherwise identify a monitoring scheme for cell(s) in the set of cells. For example, if the trigger signal indicates that the set of active RS formats corresponds to row 305-a, then the UE may (e.g., based on the configuration signaling) know that both the PCell and SCell1 will be performing RS transmissions using the legacy TRS RS format. If the trigger signal indicates that the set of active RS formats corresponds to row 305-c, then the UE may (e.g., based on the configuration signaling) know that PCell will be performing RS transmissions using the A-CSI-RS RS format and that SCell1 will be performing RS transmissions using the new temporary RS format. As SCell2 and SCell3 are both in an inactive inactivation state, the UE may disregard the RS formats for these cells.

Accordingly, the UE may perform the monitoring scheme for RS transmissions from the cell(s) in the set of cells according to the active RS format configured by the RRC configuration signaling and the activation state of each cell. For example, the UE may refraining from monitoring for RS transmissions from an already activated cell configured with a temporary aperiodic RS format (e.g., the new temporary RS format), but may monitor for RS transmissions from an already activated cell configured with a TRS RS format (e.g., the legacy TRS format and/or A-CSI-RS format). In another example, the UE may monitor for RS transmissions from a to-be-activated cell configured with a temporary aperiodic RS format (e.g., the new temporary RS format), but may refrain from monitoring for RS transmissions from a to-be-activated cell configured with a TRS RS format (e.g., the legacy TRS format and/or A-CSI-RS format).

Turning now to RS format configuration 300-b of FIG. 3B, again each set of RS formats may correspond to a row 315. For example, row 315-a may correspond to a first set of RS formats, row 315-b may correspond to a second set of RS formats, row 315-c may correspond to a third set of RS formats, and row 315-d may correspond to a fourth set of RS formats. It is to be understood that the set of RS formats may include more or fewer sets of RS formats (e.g., more rows 315 or fewer rows 315). The top row (not labeled) of RS format configuration 300-b may simply be a header row.

Each set of RS formats may map RS formats to respective cells of the set of cells. The set of cells in this example may correspond to a PCell mapped to column 320-b. SCell mapped to column 320-c. SCell2 mapped to column 320-d, and SCell3 mapped to column 320-e. Column 320-a may correspond to a set of field values that can be included in a trigger signal to indicate which set of RS formats are active. It is to be understood that the set of cells may include more or fewer cells in the sets of cells (e.g., more columns 320 or fewer columns 320). The first column 320-a generally corresponds to a set of field values that may be provided in a triggers signal to indicate which set of RS formats are active.

RS format configuration 300-b illustrates an example where the configuration signaling may include more than one RS format configured for each set of RS format for one or more cells in the set of cells. That is, the UE may identify or otherwise determine that the RS format associated with at least one SCell includes a first RS format and a second RS format. Each RS format in this example may be associated with a particular activation state of the cell(s) in the set of cells. For example, when the trigger signal indicates “00” signaling that row 315-a is the active set of RS formats, the UE may determine the activation state for SCell1, SCell2, and SCell3. If the activation state for each cell is an active activation state (e.g., already active), then the UE may determine that the active RS format for each cell is the legacy TRS RS format. If the activation state for each cell is the to-be-activated activation state (e.g., the SCell is being activated, such as based on the UE receiving an SCell activation message), then the UE may determine that the active RS format for each cell is the new temporary RS format.

Accordingly, the UE may select and perform the monitoring scheme for each cell using the active RS format based on the activation state for each cell. For example, if the trigger signal indicates “10” signaling that row 315-c corresponds to the active set of RS formats, the monitoring scheme may include the UE monitoring for RS transmissions using the A-CSI-RS format from SCell1 if SCell1 is in the already activated activation state or using the new temporary RS format if SCell1 is in the to-be-activated activation state. Accordingly, the UE may perform the monitoring scheme for the cell(s) in the set of cells according to the configured and activated set of RS formats and the activation state of each cell.

Accordingly, aspects of the described techniques may include using an A-CSI request field in an uplink DCI (e.g., DCI formats 0_1 and/or 0_2) to indicate the triggered RS. For a serving cell associated with a codepoint of the field, the RRC signaling may configure one or multiple temporary RS structures (e.g., formats) for each serving cell, where the actual RS format is identified based on certain conditions. For example, an A-CSI request field indicating “10” may activate either an A-CSI-RS or the new temporary RS format for SCell1, depending on the conditions (e.g., activation state) of SCell1 and either the legacy TRS or the new temporary RS format for SCell2 depending on the conditions of SCell2. As one non-limiting example, if SCell1 is in the inactive activation state, the field may be considered to trigger the new temporary RS format for SCell1 (e.g., SCell1 is being activated). If SCell1 is in the active activation state, the field may be considered to trigger the A-CSI-RS on SCell1.

For a serving cell associated with a codepoint of the field, the RRC configuration signaling configures one or multiple temporary RS(s) structure(s) (e.g., formats) for each serving cell and the actual temporary RS format may be identified based on a certain (set of) condition(s).

For example, the condition(s) may be whether or not the cell indicated by the field is associated with an SCell activation procedure. The SCell activation procedure may start from slot n+k, where n is the slot where the MAC-CE SCell activation command for the SCell is received and k may be k1+N+1, where k1 is the time offset for HARQ-ACK feedback for the PDSCH carrying the MAC-CE SCell activation command and N is the number of slots corresponding to 3 ms and until slot n+M, where M corresponds to a number of slots corresponding to a certain time period that is necessary for SCell activation (e.g., 20 ms). If the DCI triggering the A-CSI-RS, legacy TRS, or new temporary RS on a SCell is received from slot n+k until slot n+M, the field triggers a RS(s) necessary for SCell activation procedure (e.g., the new temporary RS(s) format). If the DCI triggering the A-CSI-RS, legacy TRS, or new temporary RS on a SCell is received after slot n+M, the field triggers a RS(s) format useful for active SCell (e.g., A-CSI-RS or legacy TRS). If the DCI triggering the A-CSI-RS, legacy TRS, or new temporary RS forma on a SCell is received before slot n+k, the UE may ignore the indication for the SCell. The exact values of k and M may be different from the above, and may depend on various other factors.

Accordingly, the UE may identify or otherwise determine that the trigger signal is received during a time window bound by a first threshold time limit and a second threshold time limit. The first threshold time limit may correspond to the delay time after receipt of the SCell activation message activating the SCell. The second threshold time limit may correspond to the activation time for the SCell. The UE may apply the active set of RS formats when the trigger signal is received during the time window or refrain from applying the active set of RS formats when the trigger signal is received prior to the time window. If the trigger signal is receive after the time window, the UE may apply a RS format associated with an activated state of the SCell (e.g., the legacy TRS and/or A-CSI-RS formats) for the activated SCell (e.g., regardless of the active set of RS formats.

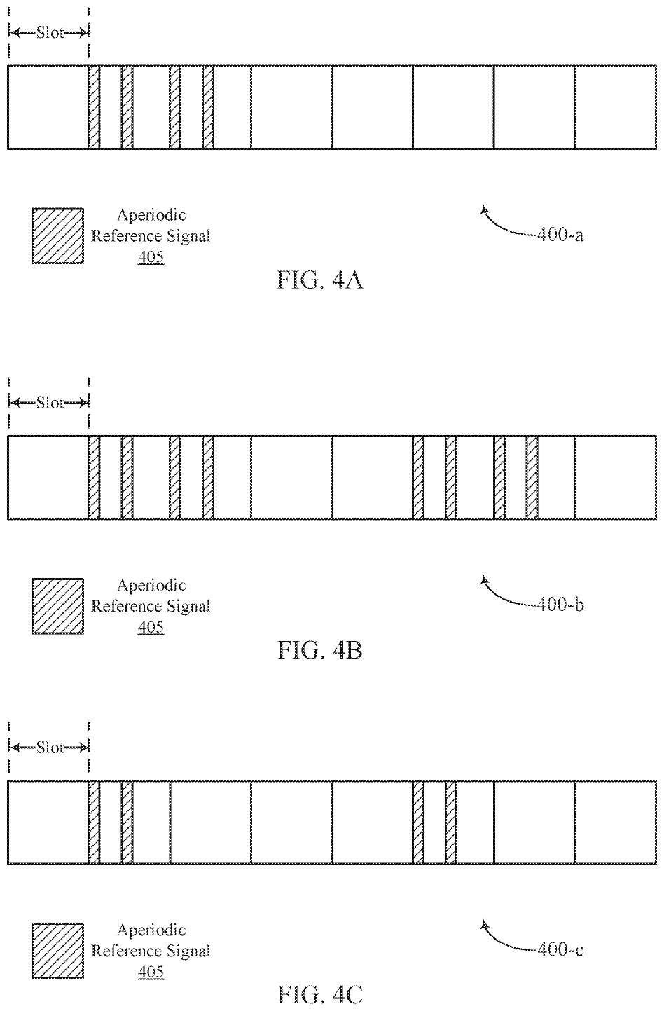

FIGS. 4A-4C illustrate examples of a RS format structure 400 that supports RS signaling for SCells in accordance with aspects of the present disclosure. RS format structure 400 may implement aspects of wireless communication systems 100 and/or 200, and/or aspects of RS format configuration 300. Aspects of RS format structure 400 may be implemented by a UE and/or network entity(ies), which may be examples of the corresponding devices described herein. The network entity(ies) in this example may be configured as PCell and/or SCells (e.g., a set of cells) available for communications with the UE. Broadly, RS format structure 400-a of FIG. 4A, RS format structure 400-b of FIG. 4B, and RS format structure 400-c illustrate non-limiting examples of structures of how the RS transmissions may be performed by cell(s) within the set of cells.

As discussed above, aspects of the described techniques provide various mechanisms that may improve RS transmissions from cell(s) available for communications with the UE. For example, a network entity may use configuration signaling (e.g., RRC signaling) to configure or otherwise indicate to the UE one or more sets of RS formats. Each set of RS formats may map RS formats to respective cells of the set of cells. The set of cells in this example may correspond to a PCell and one or more SCells. The network entity may then transmit a trigger signal to the UE that carries or otherwise conveys an indication of an active set of RS formats of the sets of RS formats. Broadly, the trigger signal may indicate that RS transmissions from the cells in the set of cells are to be performed in accordance with the RS formats associated with the active set of RS formats.

The UE may then determine the activation state for each cell in the set of cells. The activation state may generally correspond to an active activation state (e.g., that the cell is already in the active state), an inactive state, or a to-be-activated state (e.g., for a cell that is being activated for communications with the UE). Cell(s) in the active state may be known to the UE (e.g., since the UE is already communicating with the active cell(s)). Cell(s) in the inactive state may be known or unknown to the UE (e.g., the UE may or may not have been configured with inactive cell(s)). Cell(s) in the to-be-activated state may be known to the UE based on the network entity transmitting or otherwise conveying a SCell activation message to the UE identifying which cell(s) are being activated for communications with the UE.

Based on the activation state of each cell as well as the active set of RS formats indicated in the trigger signal, the UE may select, determine, or otherwise identify a monitoring scheme for cell(s) in the set of cells. Accordingly, the UE may perform the monitoring scheme for RS transmissions from the cell(s) in the set of cells according to the active RS format configured by the RRC configuration signaling and the activation state of each cell. For example, the UE may refraining from monitoring for RS transmissions from an already activated cell configured with a temporary aperiodic RS format (e.g., the new temporary RS format), but may monitor for RS transmissions from an already activated cell configured with a TRS RS format (e.g., the legacy TRS format and/or A-CSI-RS format). In another example, the UE may monitor for RS transmissions from a to-be-activated cell configured with a temporary aperiodic RS format (e.g., the new temporary RS format), but may refrain from monitoring for RS transmissions from a to-be-activated cell configured with a TRS RS format (e.g., the legacy TRS format and/or A-CSI-RS format).

Turning first to RS format structure 400-a of FIG. 4A, the active RS format may include multiple portions of the RS transmissions being separated in the time domain. For example, the UE may identify or otherwise determine that the active set of RS formats includes an aperiodic RS 405 (e.g., the new temporary RS format, a legacy TRS format, and/or an A-CSI-RS format) that includes a first portion of the RS and a second portion of the RS that are in consecutive slots. For example, the first portion of the aperiodic RS 405 (which includes two RS transmission in this example) during a first slot and then the second portion of the aperiodic RS 405 (which also includes two RS transmissions in this example) during the next slot. In some examples, RS format structure 400-a may be applied with a known cell associated with a measurement cycle less than, or equal to 160 ms.

Referring to RS format structure 400-b of FIG. 4B, illustrated therein is an example where the aperiodic RS 405 may again be split into first and second portions in the consecutive slots, but are then repeated in non-consecutive slots. The first iteration of the first/second portions of aperiodic RS 405 may be used for AGC purposes by the UE and the second iteration in the non-consecutive slots may be used for fine frequency/time tuning by the UE. In some examples, the RS format structure 400-b may be applied with a known or unknown cell associated with a measurement cycle greater than 160 ms (e.g., to support both AGC and fine time/frequency tuning).

Referring to RS format structure 400-c of FIG. 4C, illustrated therein is an example where the aperiodic RS 405 is split into the first and second portions across non-consecutive slots. The first portion of aperiodic RS 405 may be used for AGC purposes by the UE during the first slot and then the second portion of the aperiodic RS 405 may be used for fine frequency/time tuning by the UE during the second slot.

As also discussed above, the aperiodic RS 405 may use various RS formats. For example, a temporary RS (e.g., aperiodic RS 405) may be a TRA (e.g., one of an A-CSI-RS and/or a NZP-CSI-RS resource set configured with the parameter trs-info) (e.g., may use one type of known A-CSI-RS formats). Additionally, or alternatively, the temporary RS (e.g., aperiodic RS 405) may be a modified TRS, such as where the first portion of the TRS is in slot n and the second portion of the TRS is in slot n+k, where k>0 (e.g., a new structure may be used for the TRS). Additionally, or alternatively, the temporary RS may be repeated TRSs, where the gap between the repeated TRSs can be separated in the time domain by a number of slots or symbols (e.g., a completely new structure may be used for the temporary RS).

Although RS format structure 400 generally shows the aperiodic RS 405 being split into two portions (e.g., to support AGC and frequency/time tuning), it is to be understood that in some examples the RS may be split into more than two portions.

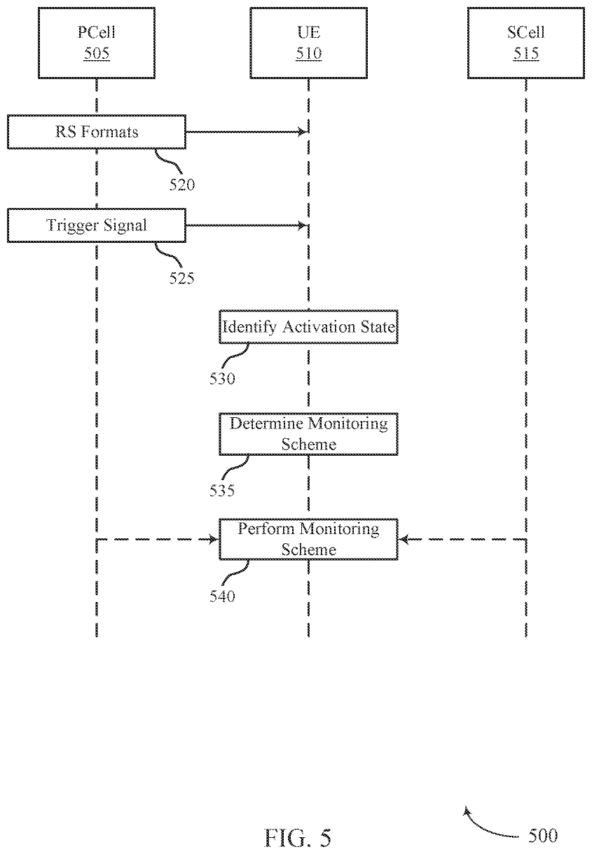

FIG. 5 illustrates an example of a process 500 that supports RS signaling for SCells in accordance with aspects of the present disclosure. Process 500 may implement aspects of wireless communication systems 100 and/or 200, RS format configuration 300, and/or RS format structure 400. Aspects of process 500 may be implemented by, or implemented at, PCell 505, UE 510, and/or SCell 515, which may be examples of the corresponding devices described herein. In some aspects, PCell 505 and SCell 515 may be associated with the same network entity or with separate network entities. It is to be understood that more than one SCell may be included in the set of cells available for communications with UE 510.

At 520, PCell 505 may transmit or otherwise provide (and UE 510 may receive or otherwise obtain) a configuration signal that carries or otherwise conveys an indication of one or more sets of RS formats. Each set of RS formats may be mapped to, or otherwise associated with, RS formats for respective cells of the set of cells. In some aspects, the configuration signaling may include RRC signaling or some other higher layer signaling used to convey the indication of the sets of RS formats. In some examples, the indication may be associated with a table having multiple rows, with each row corresponding to a different set of RS formats and each column corresponding to a different cell within the set of cells.

At 525, PCell 505 may transmit or otherwise provide (and UE 510 may receive or otherwise obtain) a trigger signal indicating an active set of RS formats from the configured set of RS formats. The trigger signal may indicate to UE 510 that RS transmissions from the cells in the set of cells will be performed in accordance with the RS formats associated with the active set of RS formats. In one non-limiting example, the trigger signal may include a DCI and the indication of the active set of RS formats may be conveyed in an A-CSI request field of the DCL. In other examples, the trigger signal may be conveyed in a MAC CE, or some other signaling between PCell 505 and UE 510. In some examples, the indication carried or otherwise conveyed in the trigger signal may include a field value associated with a particular row in the table listing the sets of RS formats.

At 530, UE 510 may determine or otherwise identify the activation state for each cell in the set of cells. For example, UE 505 may determine whether each cell (e.g., each SCell) is in an activated state where the cell is already active for communicating with UE 510, an inactive or de-active state where the cell is not communicating with UE 510, or is in a to-be-activated state where the cell is in the process of being activated for communications with UE 510. For example, PCell 505 may transmit or otherwise provide (and UE 510 may receive or otherwise obtain) an SCell activation message indicating that one or more of the cells in the set of cells are being activated for UE 510. The activation state for those one or more cells may be based on the SCell activation message.

At 535, UE 510 may use the activation state of each cell in combination with the set of active RS formats indicated by the trigger signal to identify or otherwise determine a monitoring scheme for at least one cell in the set of cells. That is, UE 510 may determine the activation state for the cell and the format for RS transmissions from the cell based on the active set of RS formats. This may indicate for UE whether or not it will monitor for RS transmissions from the cells in the set of cells and, if so, how such monitoring is to be performed (e.g., which RS format to monitor for). At 540, UE 510 may perform the monitoring scheme for RS transmissions from the at least one SCell (e.g., SCell 515) in the set of cells, in addition to RS transmission from PCell 505 in some examples. For example, UE 510 may monitor for RS transmissions from PCell 505 using the active RS format configured for PCell 505 and for RS transmissions from SCell 515 using the active RS format configured for SCell 515.

In some aspects, the monitoring scheme may be based on the activation state of the cell in addition to the RS format for the cell that is activated by the trigger signal. In one example, this may include UE 510 refraining from monitoring the RS transmissions from an already activated cell when the active RS format is a temporary aperiodic RS format (e.g., the new temporary RS format). In another example, this may include UE 510 monitoring for RS transmissions from an already activated cell when the active RS format is a TRS format (e.g., a legacy TRS format and/or an A-CSI-RS format). In yet another example, this may include UE 510 refraining from monitoring for RS transmissions from a cell being activated when the active RS format is a TRS format. Conversely, in another example this may include UE 510 monitoring for RS transmissions from a cell being activated when the active RS format is the temporary aperiodic RS format.

As discussed above, in some examples the active RS format may include multiple RS formats being configured for a cell/cells in the set of cells, with the RS format being selected based on the activation state of the cell. For example, the first RS format and the second RS format may be configured for a particular cell and indicated as active in the triggering signal. UE 510 may identify or otherwise determine the activation state of the cell and then select from the first RS format or the second RS format based on the activation state. For example, a cell may be configured with a TRS format as well as a new temporary RS format. UE 510 may select the TRS format if the Cell is already activated or the new temporary RS format if the Cell is in the process of being activated, or vice versa.

As also discussed above, in some examples the RS transmissions may be separated into first portions and second portions, which may be in consecutive slots or in non-consecutive slots. In an example where the first portion and second portion are configured in consecutive slots, this particular RS structure may be repeated across nonconsecutive slots by the cell in its RS transmissions.

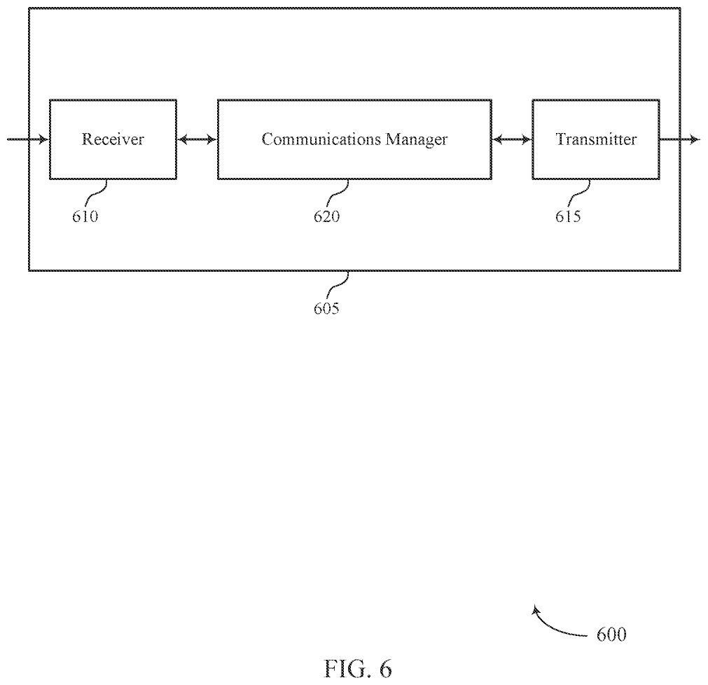

FIG. 6 shows a block diagram 600 of a device 605 that supports RS signaling for SCells in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RS signaling for SCells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RS signaling for SCells). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RS signaling for SCells as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving a configuration signal indicating one or more sets of RS formats, each set of RS formats including a mapping of RS formats to respective cells of a set of cells. The communications manager 620 may be configured as or otherwise support a means for receiving a trigger signal indicating an active set of RS formats of the one or more sets of RS formats, the trigger signal indicative of RS transmission from the cells of the set of cells in accordance with the RS formats associated with the active set of RS formats. The communications manager 620 may be configured as or otherwise support a means for identifying an activation state for each cell in the set of cells. The communications manager 620 may be configured as or otherwise support a means for determining a monitoring scheme for at least one SCell of the set of cells based on a respective activation state of the at least one SCell and a respective RS format in the active set of RS formats. The communications manager 620 may be configured as or otherwise support a means for performing the monitoring scheme with respect to RS transmissions from the at least one SCell.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for signaling RS formats/activation status for cell(s) in a set of cells configured for communications with a UE.

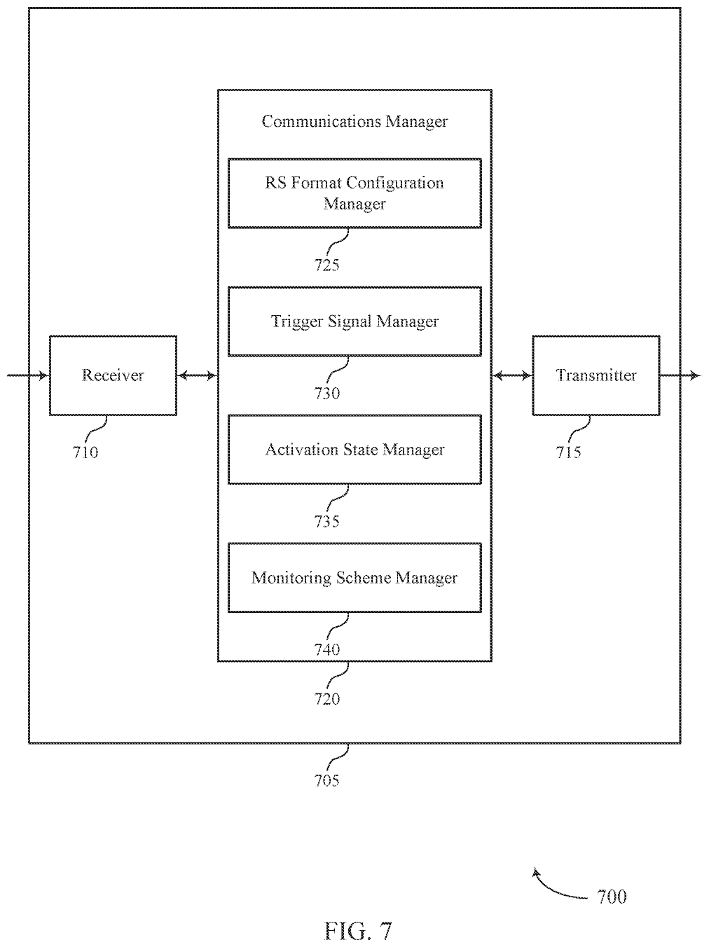

FIG. 7 shows a block diagram 700 of a device 705 that supports RS signaling for SCells in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RS signaling for SCells). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RS signaling for SCells). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RS signaling for SCells as described herein. For example, the communications manager 720 may include an RS format configuration manager 725, a trigger signal manager 730, an activation state manager 735, a monitoring scheme manager 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The RS format configuration manager 725 may be configured as or otherwise support a means for receiving a configuration signal indicating one or more sets of RS formats, each set of RS formats including a mapping of RS formats to respective cells of a set of cells. The trigger signal manager 730 may be configured as or otherwise support a means for receiving a trigger signal indicating an active set of RS formats of the one or more sets of RS formats, the trigger signal indicative of RS transmission from the cells of the set of cells in accordance with the RS formats associated with the active set of RS formats. The activation state manager 735 may be configured as or otherwise support a means for identifying an activation state for each cell in the set of cells. The monitoring scheme manager 740 may be configured as or otherwise support a means for determining a monitoring scheme for at least one SCell of the set of cells based on a respective activation state of the at least one SCell and a respective RS format in the active set of RS formats. The monitoring scheme manager 740 may be configured as or otherwise support a means for performing the monitoring scheme with respect to RS transmissions from the at least one SCell.

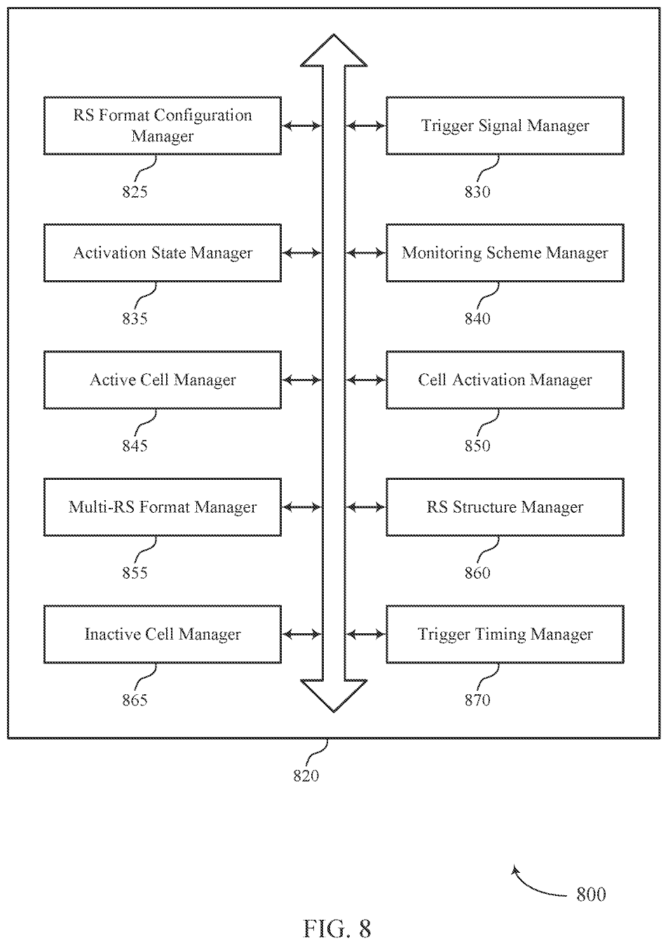

FIG. 8 shows a block diagram 800 of a communications manager 820 that supports RS signaling for SCells in accordance with aspects of the present disclosure. The communications manager 820 may be an example of aspects of a communications manager 620, a communications manager 720, or both, as described herein. The communications manager 820, or various components thereof, may be an example of means for performing various aspects of RS signaling for SCells as described herein. For example, the communications manager 820 may include an RS format configuration manager 825, a trigger signal manager 830, an activation state manager 835, a monitoring scheme manager 840, an active cell manager 845, a cell activation manager 850, a multi-RS format manager 855, an RS structure manager 860, an inactive cell manager 865, a trigger timing manager 870, or any combination thereof. Each of these components may communicate, directly or indirectly, with one another (e.g., via one or more buses).

The communications manager 820 may support wireless communication at a UE in accordance with examples as disclosed herein. The RS format configuration manager 825 may be configured as or otherwise support a means for receiving a configuration signal indicating one or more sets of RS formats, each set of RS formats including a mapping of RS formats to respective cells of a set of cells. The trigger signal manager 830 may be configured as or otherwise support a means for receiving a trigger signal indicating an active set of RS formats of the one or more sets of RS formats, the trigger signal indicative of RS transmission from the cells of the set of cells in accordance with the RS formats associated with the active set of RS formats. The activation state manager 835 may be configured as or otherwise support a means for identifying an activation state for each cell in the set of cells. The monitoring scheme manager 840 may be configured as or otherwise support a means for determining a monitoring scheme for at least one SCell of the set of cells based on a respective activation state of the at least one SCell and a respective RS format in the active set of RS formats. In some examples, the monitoring scheme manager 840 may be configured as or otherwise support a means for performing the monitoring scheme with respect to RS transmissions from the at least one SCell.

In some examples, the active cell manager 845 may be configured as or otherwise support a means for determining that the activation state of the at least one SCell is an activated state, where the at least one SCell is already activated. In some examples, the active cell manager 845 may be configured as or otherwise support a means for determining that the RS format associated with the at least one SCell in the active set of RS formats includes a temporary aperiodic RS format. In some examples, the active cell manager 845 may be configured as or otherwise support a means for performing the monitoring scheme for the at least one SCell by refraining from monitoring for the RS transmissions from the at least one SCell based on the activation state of the at least one SCell being the activated state and on the RS format associated with the at least one SCell in the active set of RS formats including the temporary aperiodic RS format.

In some examples, the active cell manager 845 may be configured as or otherwise support a means for determining that a downlink transmission is scheduled using overlapping resources that overlap with the RS transmissions from the at least one SCell. In some examples, the active cell manager 845 may be configured as or otherwise support a means for decoding the downlink transmission based on an assumption that the downlink transmission was either punctured or rate matched around the overlapping resources.

In some examples, the active cell manager 845 may be configured as or otherwise support a means for determining that the activation state of the at least one SCell is an activated state, where the at least one SCell is already activated. In some examples, the active cell manager 845 may be configured as or otherwise support a means for determining that the RS format associated with the at least one SCell in the active set of RS formats includes a tracking RS format. In some examples, the active cell manager 845 may be configured as or otherwise support a means for performing the monitoring scheme for the at least one SCell by monitoring for the RS transmissions from the at least one SCell based on the activation state of the at least one SCell being the activated state and on the RS format associated with the at least one SCell in the active set of RS formats including the tracking RS format.

In some examples, the cell activation manager 850 may be configured as or otherwise support a means for determining that the activation state of the at least one SCell is a to-be-activated state, where the at least one SCell is in a process of being activated. In some examples, the cell activation manager 850 may be configured as or otherwise support a means for determining that the RS format associated with the at least one SCell in the active set of RS formats includes a tracking RS format. In some examples, the cell activation manager 850 may be configured as or otherwise support a means for performing the monitoring scheme for the at least one SCell by refraining from monitoring for the RS transmissions from the at least one SCell based on the activation state of the at least one SCell being the to-be-activated state and on the RS format associated with the at least one SCell in the active set of RS formats including the tracking RS format.

In some examples, the cell activation manager 850 may be configured as or otherwise support a means for determining that the activation state of the at least one SCell is a to-be-activated activation state, where the at least one SCell is in a process of being activated. In some examples, the cell activation manager 850 may be configured as or otherwise support a means for determining that the RS format associated with the at least one SCell in the active set of RS formats includes a temporary aperiodic RS format. In some examples, the cell activation manager 850 may be configured as or otherwise support a means for performing the monitoring scheme for the at least one SCell by monitoring for the RS transmissions from the at least one SCell based on the activation state of the at least one SCell being the to-be-activated state and on the RS format associated with the at least one SCell in the active set of RS formats including the temporary aperiodic RS format.

In some examples, the multi-RS format manager 855 may be configured as or otherwise support a means for determining that the RS format associated with the at least one SCell in the active set of RS formats indicates a first RS format associated with a first activation state and a second RS format associated with a second activation state. In some examples, the multi-RS format manager 855 may be configured as or otherwise support a means for selecting the monitoring scheme for the at least one SCell based on whether the at least one SCell is in the first activation state or the second activation state.

In some examples, the multi-RS format manager 855 may be configured as or otherwise support a means for receiving a SCell activation message that indicates the at least one SCell is to be activated at the UE. In some examples, the multi-RS format manager 855 may be configured as or otherwise support a means for determining that the at least one SCell is in the first activation state based on the SCell activation message.

In some examples, the RS structure manager 860 may be configured as or otherwise support a means for identifying that the active set of RS formats of the one or more sets of RS formats includes a temporary aperiodic RS format that includes a first portion of a tracking RS and a second portion of the tracking RS, where the first portion and the second portion are in consecutive slots.

In some examples, the RS structure manager 860 may be configured as or otherwise support a means for identifying that the active set of RS formats of the one or more sets of RS formats includes a temporary aperiodic RS format that includes a first portion of a tracking RS and a second portion of the tracking RS, where the first portion and the second portion are in consecutive slots and the tracking RS is repeated in non-consecutive slots.

In some examples, the RS structure manager 860 may be configured as or otherwise support a means for identifying that the active set of RS formats of the one or more sets of RS formats includes a temporary aperiodic RS format that includes a first portion of a tracking RS and a second portion of the tracking RS, where the first portion and the second portion are in non-consecutive slots.

In some examples, the inactive cell manager 865 may be configured as or otherwise support a means for determining that the activation state of the at least one SCell is an inactive state where the at least one SCell is deactivated. In some examples, the inactive cell manager 865 may be configured as or otherwise support a means for performing the monitoring scheme for the at least one SCell by refraining from monitoring for the RS transmissions from the at least one SCell based on the activation state of the at least one SCell being the inactive state.

In some examples, the cell activation manager 850 may be configured as or otherwise support a means for receiving a SCell activation message that indicates that the at least one SCell is to be activated at the UE, where the activation state for the at least one SCell is based on the SCell activation message. In some examples, the SCell activation message is received using a MAC CE message.

In some examples, the trigger timing manager 870 may be configured as or otherwise support a means for determining that the trigger signal is received during a time window, the time window based on a delay time after the configuration signal is received and a threshold time limit. In some examples, the trigger timing manager 870 may be configured as or otherwise support a means for applying the active set of RS formats based on the trigger signal being received during the time window.

In some examples, the trigger timing manager 870 may be configured as or otherwise support a means for determining that the trigger signal is received prior to a time window, the time window based on a delay time after the configuration signal is received and a threshold time limit. In some examples, the trigger timing manager 870 may be configured as or otherwise support a means for refraining from applying the active set of RS formats based on the trigger signal being received prior to the time window.

In some examples, the trigger timing manager 870 may be configured as or otherwise support a means for determining that the trigger signal is received after a time window, the time window based on a delay time after the configuration signal is received and a threshold time limit. In some examples, the trigger timing manager 870 may be configured as or otherwise support a means for applying an active RS format of the active set of RS formats based on the trigger signal being received after the time window. In some examples, the configuration signal is received in an RRC message. In some examples, the trigger signal is received in a MAC CE or an aperiodic channel state information request field of a DCI.

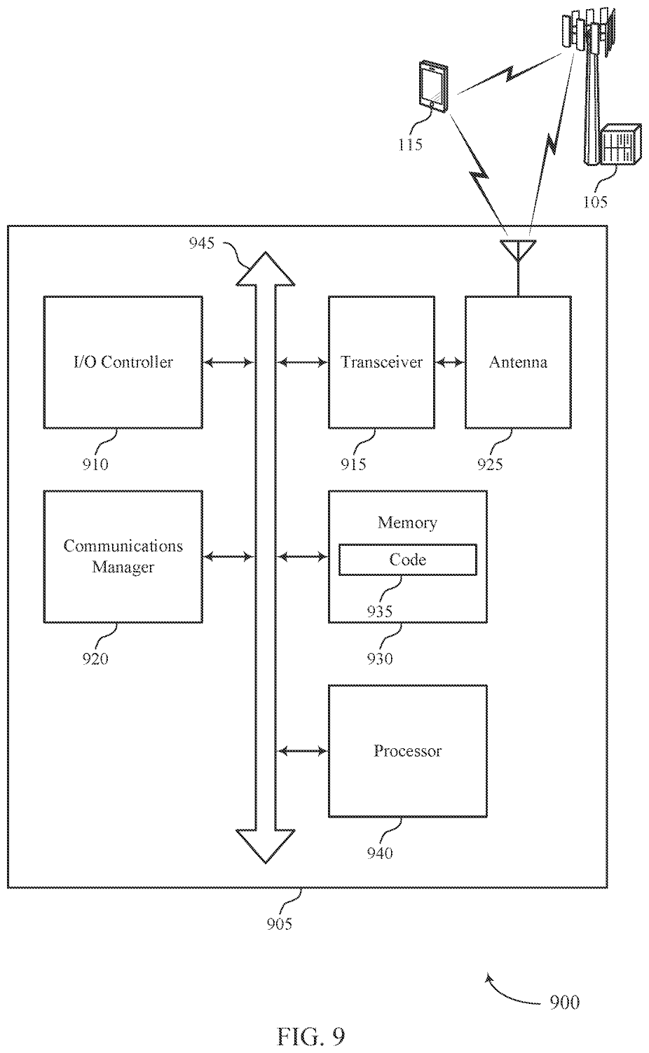

FIG. 9 shows a diagram of a system 900 including a device 905 that supports RS signaling for SCells in accordance with aspects of the present disclosure. The device 905 may be an example of or include the components of a device 605, a device 705, or a UE 115 as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RS signaling for SCells). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a configuration signal indicating one or more sets of RS formats, each set of RS formats including a mapping of RS formats to respective cells of a set of cells. The communications manager 920 may be configured as or otherwise support a means for receiving a trigger signal indicating an active set of RS formats of the one or more sets of RS formats, the trigger signal indicative of RS transmission from the cells of the set of cells in accordance with the RS formats associated with the active set of RS formats. The communications manager 920 may be configured as or otherwise support a means for identifying an activation state for each cell in the set of cells. The communications manager 920 may be configured as or otherwise support a means for determining a monitoring scheme for at least one SCell of the set of cells based on a respective activation state of the at least one SCell and a respective RS format in the active set of RS formats. The communications manager 920 may be configured as or otherwise support a means for performing the monitoring scheme with respect to RS transmissions from the at least one SCell.

By including or configuring the communications manager 920 in accordance with examples as described herein, the device 905 may support techniques for signaling RS formats/activation status for cell(s) in a set of cells configured for communications with a UE.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RS signaling for SCells as described herein, or the processor 940 and the memory 930 may be otherwise configured to perform or support such operations.

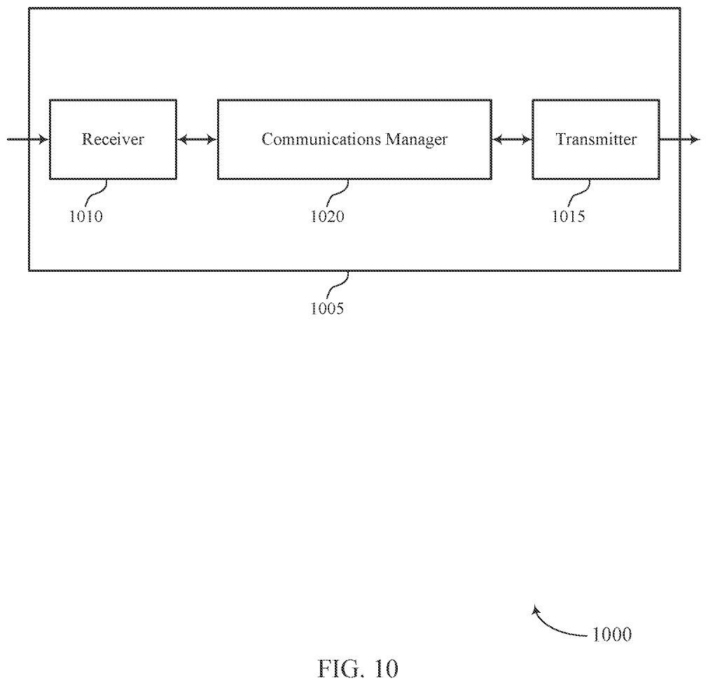

FIG. 10 shows a block diagram 1000 of a device 1005 that supports RS signaling for SCells in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to RS signaling for SCells). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to RS signaling for SCells). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of RS signaling for SCells as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. For example, the communications manager 1020 may be configured as or otherwise support a means for identifying a set of cells associated with performing communications with a UE. The communications manager 1020 may be configured as or otherwise support a means for transmitting, to the UE, a configuration signal indicating one or more sets of RS formats, each set of RS formats including a mapping of RS formats to respective cells of the set of cells. The communications manager 1020 may be configured as or otherwise support a means for transmitting, to the UE, a trigger signal indicating an active set of RS formats of the one or more sets of RS formats, the trigger signal indicative of RS transmission from the cells of the set of cells in accordance with the RS formats associated with the active set of RS formats.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for signaling RS formats/activation status for cell(s) in a set of cells configured for communications with a UE.

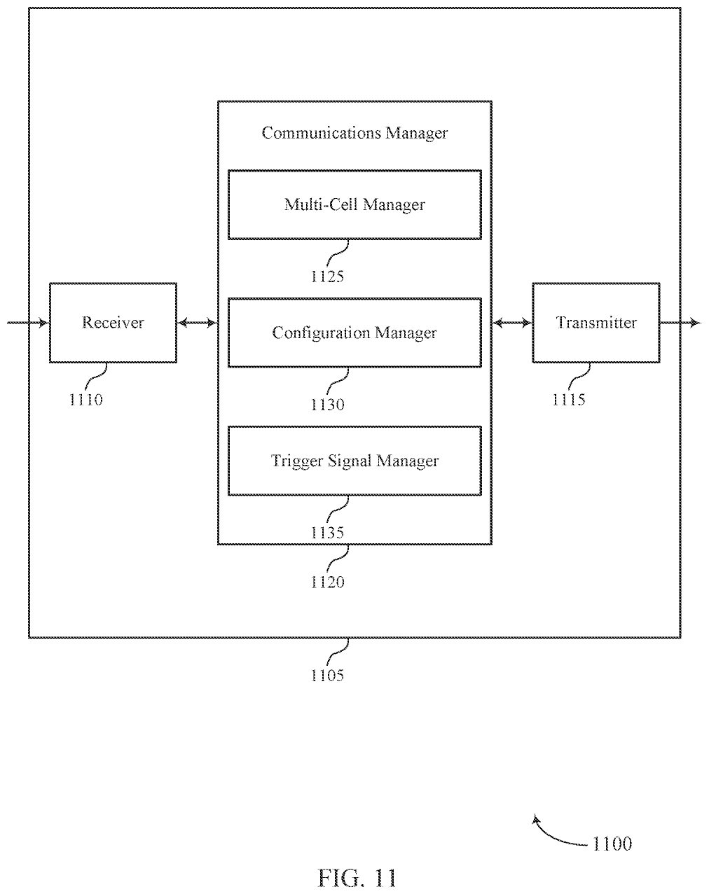

FIG. 11 shows a block diagram 1100 of a device 1105 that supports RS signaling for SCells in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to RS signaling for SCells). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to RS signaling for SCells). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of RS signaling for SCells as described herein. For example, the communications manager 1120 may include a multi-cell manager 1125, a configuration manager 1130, a trigger signal manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network entity in accordance with examples as disclosed herein. The multi-cell manager 1125 may be configured as or otherwise support a means for identifying a set of cells associated with performing communications with a UE. The configuration manager 1130 may be configured as or otherwise support a means for transmitting, to the UE, a configuration signal indicating one or more sets of RS formats, each set of RS formats including a mapping of RS formats to respective cells of the set of cells. The trigger signal manager 1135 may be configured as or otherwise support a means for transmitting, to the UE, a trigger signal indicating an active set of RS formats of the one or more sets of RS formats, the trigger signal indicative of RS transmission from the cells of the set of cells in accordance with the RS formats associated with the active set of RS formats.

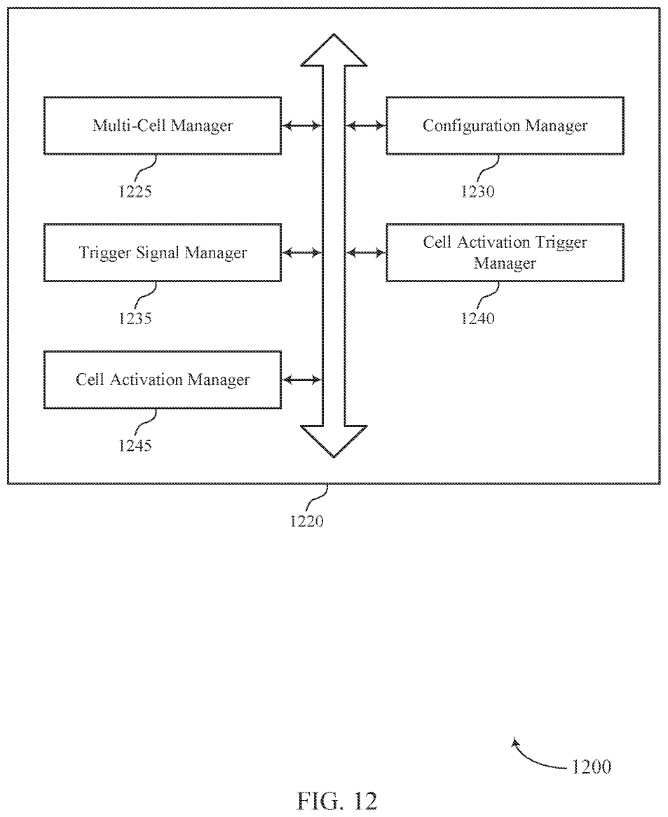

FIG. 12 shows a block diagram 1200 of a communications manager 1220 that supports RS signaling for SCells in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of RS signaling for SCells as described herein. For example, the communications manager 1220 may include a multi-cell manager 1225, a configuration manager 1230, a trigger signal manager 1235, a cell activation trigger manager 1240, a cell activation manager 1245, or any combination thereof. Each of these components may communicate, directly or indirectly, with one another (e.g., via one or more buses).

The communications manager 1220 may support wireless communication at a network entity in accordance with examples as disclosed herein. The multi-cell manager 1225 may be configured as or otherwise support a means for identifying a set of cells associated with performing communications with a UE. The configuration manager 1230 may be configured as or otherwise support a means for transmitting, to the UE, a configuration signal indicating one or more sets of RS formats, each set of RS formats including a mapping of RS formats to respective cells of the set of cells. The trigger signal manager 1235 may be configured as or otherwise support a means for transmitting, to the UE, a trigger signal indicating an active set of RS formats of the one or more sets of RS formats, the trigger signal indicative of RS transmission from the cells of the set of cells in accordance with the RS formats associated with the active set of RS formats.

In some examples, the RS format associated with at least one SCell in the active set of RS formats indicates a first RS format associated with a first activation state and a second RS format associated with a second activation state.

In some examples, the cell activation manager 1245 may be configured as or otherwise support a means for transmitting a SCell activation message to the UE that indicates the at least one SCell is to be activated at the UE, where the at least one SCell is in the first activation state based on the SCell activation message.

In some examples, the cell activation trigger manager 1240 may be configured as or otherwise support a means for transmitting a SCell activation message that indicates that at least one SCell is to be activated at the UE, where an activation state for the at least one SCell is based on the SCell activation message. In some examples, the SCell activation message is transmitted using a MAC CE message. In some examples, the configuration signal is transmitted in an RRC message. In some examples, the trigger signal is transmitted in an aperiodic channel state information request field of a DCI.

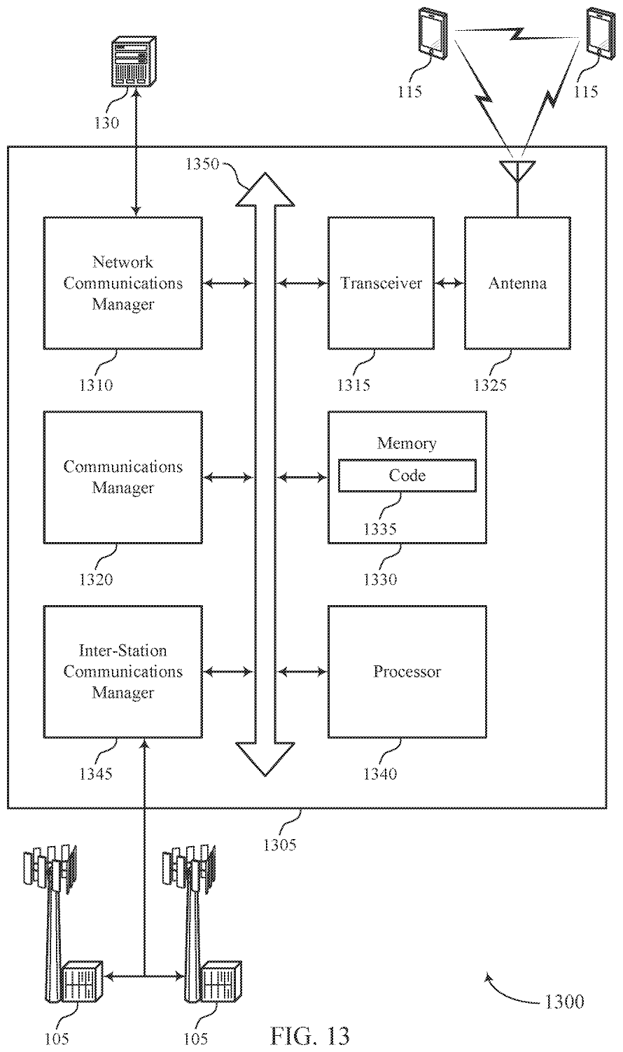

FIG. 13 shows a diagram of a system 1300 including a device 1305 that supports RS signaling for SCells in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting RS signaling for SCells). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for identifying a set of cells associated with performing communications with a UE. The communications manager 1320 may be configured as or otherwise support a means for transmitting, to the UE, a configuration signal indicating one or more sets of RS formats, each set of RS formats including a mapping of RS formats to respective cells of the set of cells. The communications manager 1320 may be configured as or otherwise support a means for transmitting, to the UE, a trigger signal indicating an active set of RS formats of the one or more sets of RS formats, the trigger signal indicative of RS transmission from the cells of the set of cells in accordance with the RS formats associated with the active set of RS formats.

By including or configuring the communications manager 1320 in accordance with examples as described herein, the device 1305 may support techniques for signaling RS formats/activation status for cell(s) in a set of cells configured for communications with a UE.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of RS signaling for SCells as described herein, or the processor 1340 and the memory 1330 may be otherwise configured to perform or support such operations.

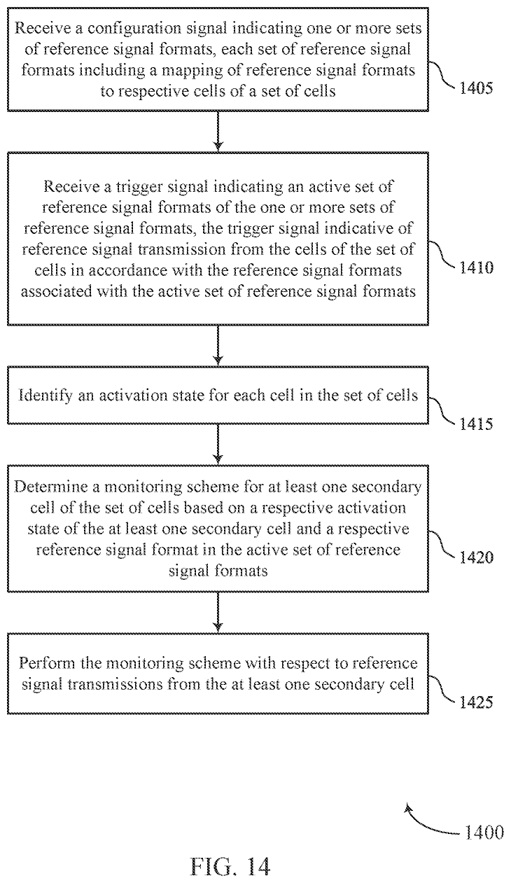

FIG. 14 shows a flowchart illustrating a method 1400 that supports RS signaling for SCells in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a configuration signal indicating one or more sets of RS formats, each set of RS formats including a mapping of RS formats to respective cells of a set of cells. The operations of 1405 may be performed in accordance with examples as disclosed herein. In some examples, aspects of the operations of 1405 may be performed by an RS format configuration manager 825 as described with reference to FIG. 8.

At 1410, the method may include receiving a trigger signal indicating an active set of RS formats of the one or more sets of RS formats, the trigger signal indicative of RS transmission from the cells of the set of cells in accordance with the RS formats associated with the active set of RS formats. The operations of 1410 may be performed in accordance with examples as disclosed herein. In some examples, aspects of the operations of 1410 may be performed by a trigger signal manager 830 as described with reference to FIG. 8.

At 1415, the method may include identifying an activation state for each cell in the set of cells. The operations of 1415 may be performed in accordance with examples as disclosed herein. In some examples, aspects of the operations of 1415 may be performed by an activation state manager 835 as described with reference to FIG. 8.

At 1420, the method may include determining a monitoring scheme for at least one SCell of the set of cells based on a respective activation state of the at least one SCell and a respective RS format in the active set of RS formats. The operations of 1420 may be performed in accordance with examples as disclosed herein. In some examples, aspects of the operations of 1420 may be performed by a monitoring scheme manager 840 as described with reference to FIG. 8.

At 1425, the method may include performing the monitoring scheme with respect to RS transmissions from the at least one SCell. The operations of 1425 may be performed in accordance with examples as disclosed herein. In some examples, aspects of the operations of 1425 may be performed by a monitoring scheme manager 840 as described with reference to FIG. 8.

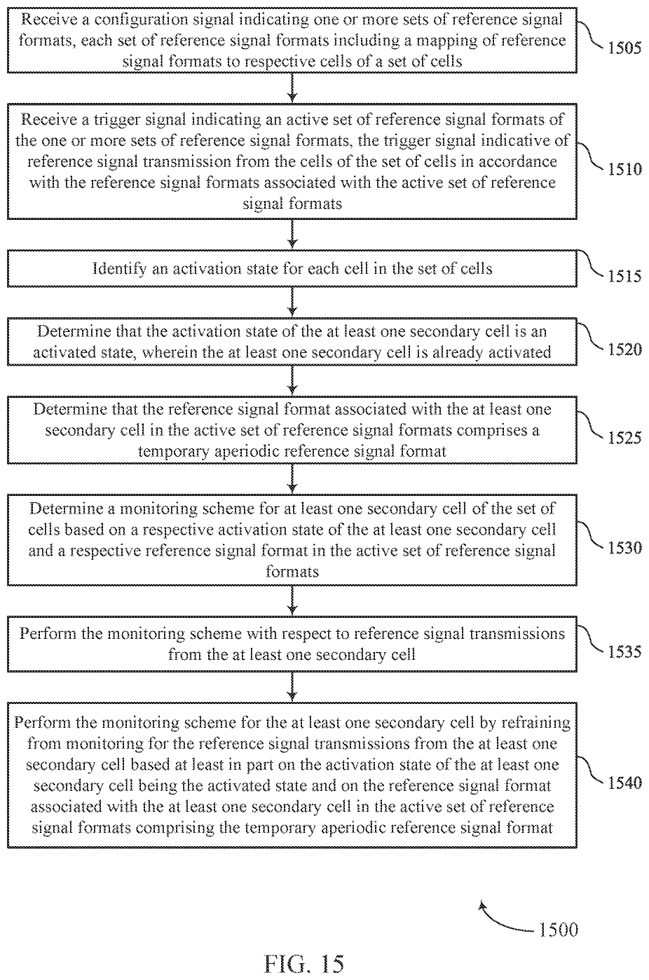

FIG. 15 shows a flowchart illustrating a method 1500 that supports RS signaling for SCells in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a configuration signal indicating one or more sets of RS formats, each set of RS formats including a mapping of RS formats to respective cells of a set of cells. The operations of 1505 may be performed in accordance with examples as disclosed herein. In some examples, aspects of the operations of 1505 may be performed by an RS format configuration manager 825 as described with reference to FIG. 8.

At 1510, the method may include receiving a trigger signal indicating an active set of RS formats of the one or more sets of RS formats, the trigger signal indicative of RS transmission from the cells of the set of cells in accordance with the RS formats associated with the active set of RS formats. The operations of 1510 may be performed in accordance with examples as disclosed herein. In some examples, aspects of the operations of 1510 may be performed by a trigger signal manager 830 as described with reference to FIG. 8.

At 1515, the method may include identifying an activation state for each cell in the set of cells. The operations of 1515 may be performed in accordance with examples as disclosed herein. In some examples, aspects of the operations of 1515 may be performed by an activation state manager 835 as described with reference to FIG. 8.

At 1520, the method may include determining that the activation state of the at least one SCell is an activated state, where the at least one SCell is already activated. The operations of 1520 may be performed in accordance with examples as disclosed herein. In some examples, aspects of the operations of 1520 may be performed by an active cell manager 845 as described with reference to FIG. 8.

At 1525, the method may include determining that the RS format associated with the at least one SCell in the active set of RS formats includes a temporary aperiodic RS format. The operations of 1525 may be performed in accordance with examples as disclosed herein. In some examples, aspects of the operations of 1525 may be performed by an active cell manager 845 as described with reference to FIG. 8.

At 1530, the method may include determining a monitoring scheme for at least one SCell of the set of cells based on a respective activation state of the at least one SCell and a respective RS format in the active set of RS formats. The operations of 1530 may be performed in accordance with examples as disclosed herein. In some examples, aspects of the operations of 1530 may be performed by a monitoring scheme manager 840 as described with reference to FIG. 8.

At 1535, the method may include performing the monitoring scheme with respect to RS transmissions from the at least one SCell. The operations of 1535 may be performed in accordance with examples as disclosed herein. In some examples, aspects of the operations of 1535 may be performed by a monitoring scheme manager 840 as described with reference to FIG. 8.

At 1540, the method may include performing the monitoring scheme for the at least one SCell by refraining from monitoring for the RS transmissions from the at least one SCell based on the activation state of the at least one SCell being the activated state and on the RS format associated with the at least one SCell in the active set of RS formats including the temporary aperiodic RS format. The operations of 1540 may be performed in accordance with examples as disclosed herein. In some examples, aspects of the operations of 1540 may be performed by an active cell manager 845 as described with reference to FIG. 8.

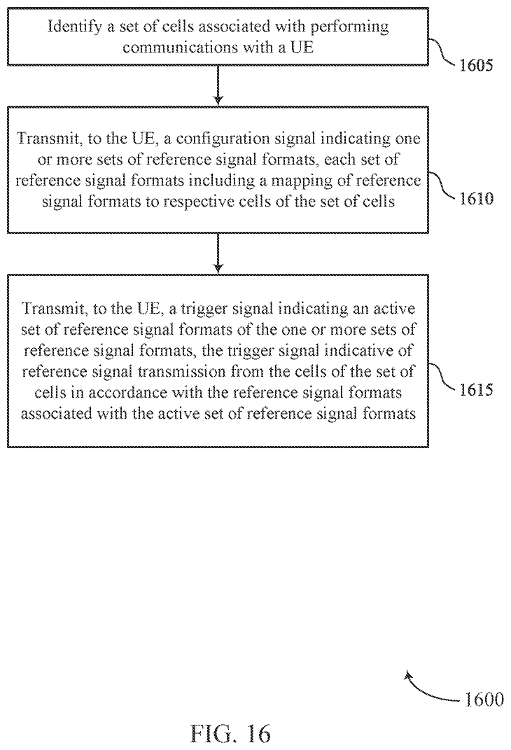

FIG. 16 shows a flowchart illustrating a method 1600 that supports RS signaling for SCells in accordance with aspects of the present disclosure. The operations of the method 1600 may be implemented by a network entity or its components as described herein. For example, the operations of the method 1600 may be performed by a network entity 105 as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include identifying a set of cells associated with performing communications with a UE. The operations of 1605 may be performed in accordance with examples as disclosed herein. In some examples, aspects of the operations of 1605 may be performed by a multi-cell manager 1225 as described with reference to FIG. 12.

At 1610, the method may include transmitting, to the UE, a configuration signal indicating one or more sets of RS formats, each set of RS formats including a mapping of RS formats to respective cells of the set of cells. The operations of 1610 may be performed in accordance with examples as disclosed herein. In some examples, aspects of the operations of 1610 may be performed by a configuration manager 1230 as described with reference to FIG. 12.

At 1615, the method may include transmitting, to the UE, a trigger signal indicating an active set of RS formats of the one or more sets of RS formats, the trigger signal indicative of RS transmission from the cells of the set of cells in accordance with the RS formats associated with the active set of RS formats. The operations of 1615 may be performed in accordance with examples as disclosed herein. In some examples, aspects of the operations of 1615 may be performed by a trigger signal manager 1235 as described with reference to FIG. 12.

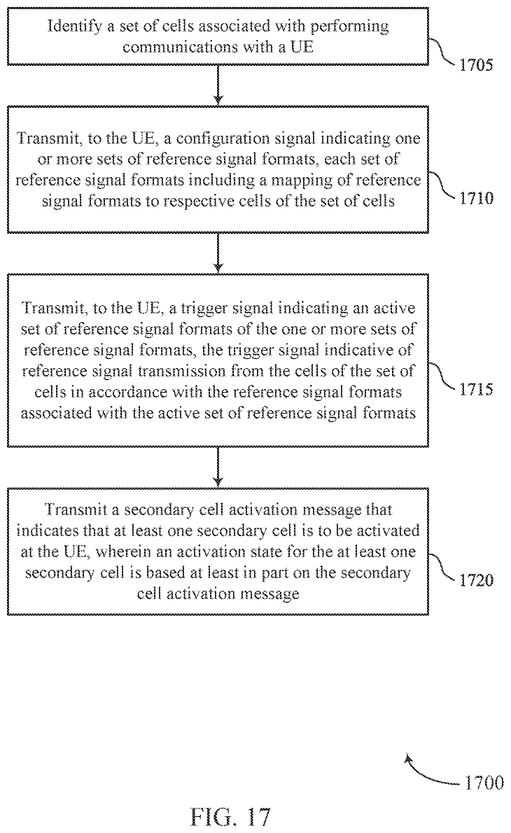

FIG. 17 shows a flowchart illustrating a method 1700 that supports RS signaling for SCells in accordance with aspects of the present disclosure. The operations of the method 1700 may be implemented by a network entity or its components as described herein. For example, the operations of the method 1700 may be performed by a network entity 105 as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include identifying a set of cells associated with performing communications with a UE. The operations of 1705 may be performed in accordance with examples as disclosed herein. In some examples, aspects of the operations of 1705 may be performed by a multi-cell manager 1225 as described with reference to FIG. 12.

At 1710, the method may include transmitting, to the UE, a configuration signal indicating one or more sets of RS formats, each set of RS formats including a mapping of RS formats to respective cells of the set of cells. The operations of 1710 may be performed in accordance with examples as disclosed herein. In some examples, aspects of the operations of 1710 may be performed by a configuration manager 1230 as described with reference to FIG. 12.

At 1715, the method may include transmitting, to the UE, a trigger signal indicating an active set of RS formats of the one or more sets of RS formats, the trigger signal indicative of RS transmission from the cells of the set of cells in accordance with the RS formats associated with the active set of RS formats. The operations of 1715 may be performed in accordance with examples as disclosed herein. In some examples, aspects of the operations of 1715 may be performed by a trigger signal manager 1235 as described with reference to FIG. 12.

At 1720, the method may include transmitting a SCell activation message that indicates that at least one SCell is to be activated at the UE, where an activation state for the at least one SCell is based on the SCell activation message. The operations of 1720 may be performed in accordance with examples as disclosed herein. In some examples, aspects of the operations of 1720 may be performed by a cell activation trigger manager 1240 as described with reference to FIG. 12.

The following provides an overview of aspects of the present disclosure:

Aspect 1: A method for wireless communication at a UE, comprising: receiving a configuration signal indicating one or more sets of RS formats, each set of RS formats including a mapping of RS formats to respective cells of a set of cells; receiving a trigger signal indicating an active set of RS formats of the one or more sets of RS formats, the trigger signal indicative of RS transmission from the cells of the set of cells in accordance with the RS formats associated with the active set of RS formats; identifying an activation state for each cell in the set of cells; determining a monitoring scheme for at least one SCell of the set of cells based on a respective activation state of the at least one SCell and a respective RS format in the active set of RS formats; and performing the monitoring scheme with respect to RS transmissions from the at least one SCell.

Aspect 2: The method of aspect 1, further comprising: determining that the activation state of the at least one SCell is an activated state, wherein the at least one SCell is already activated; determining that the RS format associated with the at least one SCell in the active set of RS formats comprises a temporary aperiodic RS format; and performing the monitoring scheme for the at least one SCell by refraining from monitoring for the RS transmissions from the at least one SCell based at least in part on the activation state of the at least one SCell being the activated state and on the RS format associated with the at least one SCell in the active set of RS formats comprising the temporary aperiodic RS format.

Aspect 3: The method of aspect 2, further comprising: determining that a downlink transmission is scheduled using overlapping resources that overlap with the RS transmissions from the at least one SCell; and decoding the downlink transmission based at least in part on an assumption that the downlink transmission was either punctured or rate matched around the overlapping resources.

Aspect 4: The method of any of aspects 1 through 3, further comprising: determining that the activation state of the at least one SCell is an activated state, wherein the at least one SCell is already activated; determining that the RS format associated with the at least one SCell in the active set of RS formats comprises a tracking RS format; and performing the monitoring scheme for the at least one SCell by monitoring for the RS transmissions from the at least one SCell based at least in part on the activation state of the at least one SCell being the activated state and on the RS format associated with the at least one SCell in the active set of RS formats comprising the tracking RS format.

Aspect 5: The method of any of aspects 1 through 4, further comprising: determining that the activation state of the at least one SCell is a to-be-activated state, wherein the at least one SCell is in a process of being activated; determining that the RS format associated with the at least one SCell in the active set of RS formats comprises a tracking RS format; and performing the monitoring scheme for the at least one SCell by refraining from monitoring for the RS transmissions from the at least one SCell based at least in part on the activation state of the at least one SCell being the to-be-activated state and on the RS format associated with the at least one SCell in the active set of RS formats comprising the tracking RS format.

Aspect 6: The method of any of aspects 1 through 5, further comprising: determining that the activation state of the at least one SCell is a to-be-activated activation state, wherein the at least one SCell is in a process of being activated; determining that the RS format associated with the at least one SCell in the active set of RS formats comprises a temporary aperiodic RS format; and performing the monitoring scheme for the at least one SCell by monitoring for the RS transmissions from the at least one SCell based at least in part on the activation state of the at least one SCell being the to-be-activated state and on the RS format associated with the at least one SCell in the active set of RS formats comprising the temporary aperiodic RS format.

Aspect 7: The method of any of aspects 1 through 6, further comprising: determining that the RS format associated with the at least one SCell in the active set of RS formats indicates a first RS format associated with a first activation state and a second RS format associated with a second activation state; and selecting the monitoring scheme for the at least one SCell based at least in part on whether the at least one SCell is in the first activation state or the second activation state.

Aspect 8: The method of aspect 7, further comprising: receiving a SCell activation message that indicates the at least one SCell is to be activated at the UE; and determining that the at least one SCell is in the first activation state based at least in part on the SCell activation message.

Aspect 9: The method of any of aspects 1 through 8, further comprising: identifying that the active set of RS formats of the one or more sets of RS formats includes a temporary aperiodic RS format that includes a first portion of a tracking RS and a second portion of the tracking RS, wherein the first portion and the second portion are in consecutive slots.

Aspect 10: The method of any of aspects 1 through 9, further comprising: identifying that the active set of RS formats of the one or more sets of RS formats includes a temporary aperiodic RS format that includes a first portion of a tracking RS and a second portion of the tracking RS, wherein the first portion and the second portion are in consecutive slots and the tracking RS is repeated in non-consecutive slots.

Aspect 11: The method of any of aspects 1 through 10, further comprising: identifying that the active set of RS formats of the one or more sets of RS formats includes a temporary aperiodic RS format that includes a first portion of a tracking RS and a second portion of the tracking RS, wherein the first portion and the second portion are in non-consecutive slots.

Aspect 12: The method of any of aspects 1 through 11, further comprising: determining that the activation state of the at least one SCell is an inactive state wherein the at least one SCell is deactivated; and performing the monitoring scheme for the at least one SCell by refraining from monitoring for the RS transmissions from the at least one SCell based at least in part on the activation state of the at least one SCell being the inactive state.

Aspect 13: The method of any of aspects 1 through 12, further comprising: receiving a SCell activation message that indicates that the at least one SCell is to be activated at the UE, wherein the activation state for the at least one SCell is based at least in part on the SCell activation message.

Aspect 14: The method of aspect 13, wherein the SCell activation message is received using a MAC CE message.

Aspect 15: The method of any of aspects 1 through 14, further comprising: determining that the trigger signal is received during a time window, the time window based at least in part on a delay time after the configuration signal is received and a threshold time limit; and applying the active set of RS formats based at least in part on the trigger signal being received during the time window.

Aspect 16: The method of any of aspects 1 through 15, further comprising: determining that the trigger signal is received prior to a time window, the time window based at least in part on a delay time after the configuration signal is received and a threshold time limit; and refraining from applying the active set of RS formats based at least in part on the trigger signal being received prior to the time window.

Aspect 17: The method of any of aspects 1 through 16, further comprising: determining that the trigger signal is received after a time window, the time window based at least in part on a delay time after the configuration signal is received and a threshold time limit; and applying an active RS format of the active set of RS formats based at least in part on the trigger signal being received after the time window.

Aspect 18: The method of any of aspects 1 through 17, wherein the configuration signal is received in an RRC message.

Aspect 19: The method of any of aspects 1 through 18, wherein the trigger signal is received in a MAC CE or an aperiodic channel state information request field of a DCI

Aspect 20: A method for wireless communication at a network entity, comprising: identifying a set of cells associated with performing communications with a UE; transmitting, to the UE, a configuration signal indicating one or more sets of RS formats, each set of RS formats including a mapping of RS formats to respective cells of the set of cells; and transmitting, to the UE, a trigger signal indicating an active set of RS formats of the one or more sets of RS formats, the trigger signal indicative of RS transmission from the cells of the set of cells in accordance with the RS formats associated with the active set of RS formats.

Aspect 21: The method of aspect 20, wherein the RS format associated with at least one SCell in the active set of RS formats indicates a first RS format associated with a first activation state and a second RS format associated with a second activation state.

Aspect 22: The method of aspect 21, further comprising: transmitting a SCell activation message to the UE that indicates the at least one SCell is to be activated at the UE, wherein the at least one SCell is in the first activation state based at least in part on the SCell activation message.

Aspect 23: The method of any of aspects 20 through 22, further comprising: transmitting a SCell activation message that indicates that at least one SCell is to be activated at the UE, wherein an activation state for the at least one SCell is based at least in part on the SCell activation message.

Aspect 24: The method of aspect 23, wherein the SCell activation message is transmitted using a MAC CE message.

Aspect 25: The method of any of aspects 20 through 24, wherein the configuration signal is transmitted in an RRC message.

Aspect 26: The method of any of aspects 20 through 25, wherein the trigger signal is transmitted in an aperiodic channel state information request field of a DCI.

Aspect 27: An apparatus for wireless communication at a UE, comprising a processor; memory coupled with the processor; and instructions stored in the memory and executable by the processor to cause the apparatus to perform a method of any of aspects 1 through 19.

Aspect 28: An apparatus for wireless communication at a UE, comprising at least one means for performing a method of any of aspects 1 through 19.

Aspect 29: A non-transitory computer-readable medium storing code for wireless communication at a UE, the code comprising instructions executable by a processor to perform a method of any of aspects 1 through 19.

Aspect 30: An apparatus for wireless communication at a network entity, comprising a processor; memory coupled with the processor; and instructions stored in the memory and executable by the processor to cause the apparatus to perform a method of any of aspects 20 through 26.

Aspect 31: An apparatus for wireless communication at a network entity, comprising at least one means for performing a method of any of aspects 20 through 26.

Aspect 32: A non-transitory computer-readable medium storing code for wireless communication at a network entity, the code comprising instructions executable by a processor to perform a method of any of aspects 20 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a configuration signal indicating one or more sets of reference signal formats, each set of reference signal formats including a mapping of reference signal formats to respective cells of a set of cells;
receiving a trigger signal indicating an active set of reference signal formats of the one or more sets of reference signal formats, the trigger signal indicative of reference signal transmission from the cells of the set of cells in accordance with the reference signal formats associated with the active set of reference signal formats;
identifying an activation state for each cell in the set of cells;
determining a monitoring scheme for at least one secondary cell of the set of cells based on a respective activation state of the at least one secondary cell and a respective reference signal format in the active set of reference signal formats; and
performing the monitoring scheme with respect to reference signal transmissions from the at least one secondary cell.

2. The method of claim 1, further comprising:
determining that the activation state of the at least one secondary cell is an activated state, wherein the at least one secondary cell is already activated;
determining that the reference signal format associated with the at least one secondary cell in the active set of reference signal formats comprises a temporary aperiodic reference signal format; and
performing the monitoring scheme for the at least one secondary cell by refraining from monitoring for the reference signal transmissions from the at least one secondary cell based at least in part on the activation state of the at least one secondary cell being the activated state and on the reference signal format associated with the at least one secondary cell in the active set of reference signal formats comprising the temporary aperiodic reference signal format.

3. The method of claim 2, further comprising:
determining that a downlink transmission is scheduled using overlapping resources that overlap with the reference signal transmissions from the at least one secondary cell; and
decoding the downlink transmission based at least in part on an assumption that the downlink transmission was either punctured or rate matched around the overlapping resources.

4. The method of claim 1, further comprising:
determining that the activation state of the at least one secondary cell is an activated state, wherein the at least one secondary cell is already activated;
determining that the reference signal format associated with the at least one secondary cell in the active set of reference signal formats comprises a tracking reference signal format; and
performing the monitoring scheme for the at least one secondary cell by monitoring for the reference signal transmissions from the at least one secondary cell based at least in part on the activation state of the at least one secondary cell being the activated state and on the reference signal format associated with the at least one secondary cell in the active set of reference signal formats comprising the tracking reference signal format.

5. The method of claim 1, further comprising:
determining that the activation state of the at least one secondary cell is a to-be-activated state, wherein the at least one secondary cell is in a process of being activated;
determining that the reference signal format associated with the at least one secondary cell in the active set of reference signal formats comprises a tracking reference signal format; and
performing the monitoring scheme for the at least one secondary cell by refraining from monitoring for the reference signal transmissions from the at least one secondary cell based at least in part on the activation state of the at least one secondary cell being the to-be-activated state and on the reference signal format associated with the at least one secondary cell in the active set of reference signal formats comprising the tracking reference signal format.

6. The method of claim 1, further comprising:
determining that the activation state of the at least one secondary cell is a to-be-activated activation state, wherein the at least one secondary cell is in a process of being activated;
determining that the reference signal format associated with the at least one secondary cell in the active set of reference signal formats comprises a temporary aperiodic reference signal format; and
performing the monitoring scheme for the at least one secondary cell by monitoring for the reference signal transmissions from the at least one secondary cell based at least in part on the activation state of the at least one secondary cell being the to-be-activated state and on the reference signal format associated with the at least one secondary cell in the active set of reference signal formats comprising the temporary aperiodic reference signal format.

7. The method of claim 1, further comprising:
determining that the reference signal format associated with the at least one secondary cell in the active set of reference signal formats indicates a first reference signal format associated with a first activation state and a second reference signal format associated with a second activation state; and
selecting the monitoring scheme for the at least one secondary cell based at least in part on whether the at least one secondary cell is in the first activation state or the second activation state.

8. The method of claim 7, further comprising:
receiving a secondary cell activation message that indicates the at least one secondary cell is to be activated at the UE; and
determining that the at least one secondary cell is in the first activation state based at least in part on the secondary cell activation message.

9. The method of claim 1, further comprising:
identifying that the active set of reference signal formats of the one or more sets of reference signal formats includes a temporary aperiodic reference signal format that includes a first portion of a tracking reference signal and a second portion of the tracking reference signal, wherein the first portion and the second portion are in consecutive slots.

10. The method of claim 1, further comprising:
identifying that the active set of reference signal formats of the one or more sets of reference signal formats includes a temporary aperiodic reference signal format that includes a first portion of a tracking reference signal and a second portion of the tracking reference signal, wherein the first portion and the second portion are in consecutive slots and the tracking reference signal is repeated in non-consecutive slots.

11. The method of claim 1, further comprising:
identifying that the active set of reference signal formats of the one or more sets of reference signal formats includes a temporary aperiodic reference signal format that includes a first portion of a tracking reference signal and a second portion of the tracking reference signal, wherein the first portion and the second portion are in non-consecutive slots.

12. The method of claim 1, further comprising:
determining that the activation state of the at least one secondary cell is an inactive state wherein the at least one secondary cell is deactivated; and
performing the monitoring scheme for the at least one secondary cell by refraining from monitoring for the reference signal transmissions from the at least one secondary cell based at least in part on the activation state of the at least one secondary cell being the inactive state.

13. The method of claim 1, further comprising:
receiving a secondary cell activation message that indicates that the at least one secondary cell is to be activated at the UE, wherein the activation state for the at least one secondary cell is based at least in part on the secondary cell activation message.

14. The method of claim 13, wherein the secondary cell activation message is received using a medium access control (MAC) control element (CE) message.

15. The method of claim 1, further comprising:
determining that the trigger signal is received during a time window, the time window based at least in part on a delay time after the configuration signal is received and a threshold time limit; and
applying the active set of reference signal formats based at least in part on the trigger signal being received during the time window.

16. The method of claim 1, further comprising:
determining that the trigger signal is received prior to a time window, the time window based at least in part on a delay time after the configuration signal is received and a threshold time limit; and
refraining from applying the active set of reference signal formats based at least in part on the trigger signal being received prior to the time window.

17. The method of claim 1, further comprising:
determining that the trigger signal is received after a time window, the time window based at least in part on a delay time after the configuration signal is received and a threshold time limit; and
applying an active reference signal format of the active set of reference signal formats based at least in part on the trigger signal being received after the time window.

18. The method of claim 1, wherein the configuration signal is received in a radio resource control (RRC) message.

19. The method of claim 1, wherein the trigger signal is received in a medium access control (MAC) control element (CE) or an aperiodic channel state information request field of a downlink control information (DCI).

20. An apparatus for wireless communication at a user equipment (UE), comprising:
a processor;
memory coupled with the processor; and
instructions stored in the memory and executable by the processor to cause the apparatus to:
receive a configuration signal indicating one or more sets of reference signal formats, each set of reference signal formats including a mapping of reference signal formats to respective cells of a set of cells;
receive a trigger signal indicating an active set of reference signal formats of the one or more sets of reference signal formats, the trigger signal indicative of reference signal transmission from the cells of the set of cells in accordance with the reference signal formats associated with the active set of reference signal formats;
identify an activation state for each cell in the set of cells;
determine a monitoring scheme for at least one secondary cell of the set of cells based on a respective activation state of the at least one secondary cell and a respective reference signal format in the active set of reference signal formats; and
perform the monitoring scheme with respect to reference signal transmissions from the at least one secondary cell.

21. The apparatus of claim 20, wherein the instructions are further executable by the processor to cause the apparatus to:
determine that the activation state of the at least one secondary cell is an activated state, wherein the at least one secondary cell is already activated;
determine that the reference signal format associated with the at least one secondary cell in the active set of reference signal formats comprises a temporary aperiodic reference signal format; and
perform the monitoring scheme for the at least one secondary cell by refraining from monitoring for the reference signal transmissions from the at least one secondary cell based at least in part on the activation state of the at least one secondary cell being the activated state and on the reference signal format associated with the at least one secondary cell in the active set of reference signal formats comprising the temporary aperiodic reference signal format.

22. The apparatus of claim 21, wherein the instructions are further executable by the processor to cause the apparatus to:
determine that a downlink transmission is scheduled using overlapping resources that overlap with the reference signal transmissions from the at least one secondary cell; and
decode the downlink transmission based at least in part on an assumption that the downlink transmission was either punctured or rate matched around the overlapping resources.

23. The apparatus of claim 20, wherein the instructions are further executable by the processor to cause the apparatus to:
determine that the activation state of the at least one secondary cell is an activated state, wherein the at least one secondary cell is already activated;
determine that the reference signal format associated with the at least one secondary cell in the active set of reference signal formats comprises a tracking reference signal format; and
perform the monitoring scheme for the at least one secondary cell by monitoring for the reference signal transmissions from the at least one secondary cell based at least in part on the activation state of the at least one secondary cell being the activated state and on the reference signal format associated with the at least one secondary cell in the active set of reference signal formats comprising the tracking reference signal format.

24. The apparatus of claim 20, wherein the instructions are further executable by the processor to cause the apparatus to:
determine that the activation state of the at least one secondary cell is a to-be-activated state, wherein the at least one secondary cell is in a process of being activated;
determine that the reference signal format associated with the at least one secondary cell in the active set of reference signal formats comprises a tracking reference signal format; and
perform the monitoring scheme for the at least one secondary cell by refraining from monitoring for the reference signal transmissions from the at least one secondary cell based at least in part on the activation state of the at least one secondary cell being the to-be-activated state and on the reference signal format associated with the at least one secondary cell in the active set of reference signal formats comprising the tracking reference signal format.

25. The apparatus of claim 20, wherein the instructions are further executable by the processor to cause the apparatus to:
determine that the activation state of the at least one secondary cell is a to-be-activated activation state, wherein the at least one secondary cell is in a process of being activated;
determine that the reference signal format associated with the at least one secondary cell in the active set of reference signal formats comprises a temporary aperiodic reference signal format; and
perform the monitoring scheme for the at least one secondary cell by monitoring for the reference signal transmissions from the at least one secondary cell based at least in part on the activation state of the at least one secondary cell being the to-be-activated state and on the reference signal format associated with the at least one secondary cell in the active set of reference signal formats comprising the temporary aperiodic reference signal format.

26. The apparatus of claim 20, wherein the instructions are further executable by the processor to cause the apparatus to:
determine that the reference signal format associated with the at least one secondary cell in the active set of reference signal formats indicates a first reference signal format associated with a first activation state and a second reference signal format associated with a second activation state; and
select the monitoring scheme for the at least one secondary cell based at least in part on whether the at least one secondary cell is in the first activation state or the second activation state.

27. The apparatus of claim 26, wherein the instructions are further executable by the processor to cause the apparatus to:
receive a secondary cell activation message that indicates the at least one secondary cell is to be activated at the UE; and
determine that the at least one secondary cell is in the first activation state based at least in part on the secondary cell activation message.

28. The apparatus of claim 20, wherein the instructions are further executable by the processor to cause the apparatus to:
identify that the active set of reference signal formats of the one or more sets of reference signal formats includes a temporary aperiodic reference signal format that includes a first portion of a tracking reference signal and a second portion of the tracking reference signal, wherein the first portion and the second portion are in consecutive slots.

29. An apparatus for wireless communication at a user equipment (UE), comprising:
means for receiving a configuration signal indicating one or more sets of reference signal formats, each set of reference signal formats including a mapping of reference signal formats to respective cells of a set of cells;
means for receiving a trigger signal indicating an active set of reference signal formats of the one or more sets of reference signal formats, the trigger signal indicative of reference signal transmission from the cells of the set of cells in accordance with the reference signal formats associated with the active set of reference signal formats;
means for identifying an activation state for each cell in the set of cells;
means for determining a monitoring scheme for at least one secondary cell of the set of cells based on a respective activation state of the at least one secondary cell and a respective reference signal format in the active set of reference signal formats; and
means for performing the monitoring scheme with respect to reference signal transmissions from the at least one secondary cell.

30. A non-transitory computer-readable medium storing code for wireless communication at a user equipment (UE), the code comprising instructions executable by a processor to:
receive a configuration signal indicating one or more sets of reference signal formats, each set of reference signal formats including a mapping of reference signal formats to respective cells of a set of cells;
receive a trigger signal indicating an active set of reference signal formats of the one or more sets of reference signal formats, the trigger signal indicative of reference signal transmission from the cells of the set of cells in accordance with the reference signal formats associated with the active set of reference signal formats;
identify an activation state for each cell in the set of cells;
determine a monitoring scheme for at least one secondary cell of the set of cells based on a respective activation state of the at least one secondary cell and a respective reference signal format in the active set of reference signal formats; and
perform the monitoring scheme with respect to reference signal transmissions from the at least one secondary cell.
